(19) United States
(12) Patent Application Publication
(10) Pub. No.: US 2025/0245898 A1
(43) Pub. Date: Jul. 31, 2025

(54) THREE-DIMENSIONAL VIDEO HIGHLIGHT FROM A CAMERA SOURCE

(71) Applicant: Google LLC, Mountain View, CA (US)

(72) Inventors: Matthieu Kim Lorrain, New York City, NY (US); Selwyn Cheetham, Paris (FR); Jihee Hwang, New York City, NY (US); John Patrick Guiseppi, II, Los Angeles, CA (US); Neil Parris, Los Angeles, CA (US); Aaron Philip Luber, Montclair, NJ (US)

(21) Appl. No.: 18/877,778

(22) PCT Filed: Jun. 30, 2023
(86) PCT No.: PCT/US2023/069511

§ 371 Date: Dec. 20, 2024

Related U.S. Application Data
(60) Provisional application No. 63/367,525, filed on Jul. 1, 2022.

(51) Int. Cl. G06T 13/20; G06T 7/579; G06V 20/40

(52) U.S. Cl. CPC G06T 13/20; G06T 7/579; G06V 20/44; G06V 20/49; G06T 2200/24; G06T 2207/10016

(57) ABSTRACT

According to an aspect, a method includes generating a three-dimensional (3D) video segment from two-dimensional (2D) video content captured by a camera system, including obtaining, from a 3D pose estimation engine, 3D movement data of an object detected in the 2D video content, and generating an animated object based on the 3D movement data such that a movement of the animated object corresponds to a movement of the object in the 2D video content. The method includes generating 3D video content from the 3D video segment and transmitting the 3D video content to a user device for display.

### CROSS-REFERENCE TO RELATED APPLICATION

This application claims priority to U.S. Provisional Patent Application No. 63/367,525, filed on Jul. 1, 2022, entitled “THREE DIMENSIONAL (3D) HIGHLIGHTS”, the disclosure of which is incorporated by reference herein in its entirety.

### BACKGROUND

Three-dimensional (3D) production may be the process of creating and producing content in three dimensions (e.g., height, width, and depth) and may encompass a variety of techniques and technologies to capture, generate, manipulate, and/or present content in a 3D format. In 3D production, content may be created or captured in a way that simulates depth perception, providing a more immersive and realistic experience. Conventional 3D production may involve a number of technical processes that may be time consuming and may use a relatively large amount of computing resources (e.g., memory, central processing unit (CPU) and/or graphics processing unit (GPU) power).

### SUMMARY

In some aspects, the techniques described herein relate to a method including: generating a three-dimensional (3D) video segment from two-dimensional (2D) video content captured by a camera system, including: obtaining, from a 3D pose estimation engine, 3D movement data of an object detected in the 2D video content; and generating an animated object based on the 3D movement data such that a movement of the animated object corresponds to a movement of the object in the 2D video content; generating 3D video content from the 3D video segment; and transmitting the 3D video content to a user device for display.

In some aspects, the techniques described herein relate to a non-transitory computer-readable medium storing executable instructions that cause at least one processor to execute operations, the operations including: transmitting, over a network, a three-dimensional (3D) viewing request to a video manager executable by at least one server computer, the 3D viewing request being a request to view two-dimensional (2D) content captured by a camera system in a 3D format; receiving, over the network, 3D video content from the video manager, the 3D video content being generated from a 3D video segment that was generated by the video manager using the 2D video content; and initiating a display of the 3D video content on an interface of a user device, the 3D video content including an animated object whose movement corresponds to a movement of an object in the 2D video content.

In some aspects, the techniques described herein relate to an apparatus including: at least one processor; and a non-transitory computer-readable medium storing executable instructions that cause the at least one processor to: receive, from a user device, a three-dimensional (3D) viewing request to view two-dimensional (2D) video content in a 3D format; retrieve, from a video database, a 3D video segment that corresponds to the 2D video content, the 3D video segment including an animated object whose movement corresponds to a movement of an object in the 2D video content; generate 3D video content from the 3D video segment; and transmit the 3D video content to the user device for display.

The details of one or more implementations are set forth in the accompanying drawings and the description below. Other features will be apparent from the description and drawings, and from the claims.

### BRIEF DESCRIPTION OF THE DRAWINGS

FIG. 1A illustrates a system for generating a three-dimensional (3D) video segment from two-dimensional (2D) video content according to an aspect.

FIG. 1B illustrates an example of a video manager for identifying 2D video segments from television content according to an aspect.

FIG. 1C illustrates an example of an object tracker for generating 3D movement data according to an aspect.

FIG. 1D illustrates an example of 3D movement data for a plurality of keypoints according to an aspect.

FIG. 1E illustrates an object tracker according to another aspect.

FIG. 1F illustrates an example of a 3D object engine configured to generate an animated object using the 3D movement data according to an aspect.

FIG. 1G illustrates an example of a 3D object engine that selects a 3D object model from an object model database according to an aspect.

FIG. 1H illustrates an example of a 3D object engine that generates a 3D object model from 2D video content according to an aspect.

FIG. 1I illustrates an interface depicting example user controls for controlling playback of the 3D video segment according to an aspect.

FIG. 1J illustrates example communications between a video manager and a user device according to an aspect.

FIG. 1K illustrates an example of a video manager for generating metadata associated with 3D video segments and searching the 3D video segments in response to a search query according to an aspect.

FIG. 1L illustrates an example of sharing customized 3D video content with another user device according to an aspect.

FIG. 1M illustrates an example of a system with a video manager executing on one or more server computers according to an aspect.

FIG. 1N illustrates an example of a system with a video manager portion executing on one or more server computers and a video manager portion executing on a user device according to an aspect.

FIGS. 2A through 2M illustrate example interfaces for displaying a 3D video segment with user controls for adjusting playback of the 3D video segment according to various aspects.

FIGS. 3A and 3B illustrate example interfaces for displaying a 3D video segment according to an aspect.

FIGS. 4A through 4C illustrate example displays of a 2D video content and 3D video content according to an aspect.

FIGS. 5A through 5C illustrate example 3D video content depicting an animated object that moves in a manner corresponding to an object in 2D video content according to an aspect.

FIG. 6 illustrates a flowchart depicting example operations of a system for generating 3D video segments according to an aspect.

FIG. 7 illustrates a flowchart depicting example operations of a system for receiving and displaying 3D video segments according to an aspect.

FIG. 8 illustrates a flowchart depicting example operations of a system for retrieving and distributing 3D video segments according to an aspect.

### DETAILED DESCRIPTION

This disclosure relates to a system that generates a three-dimensional (3D) video segment (e.g., a 3D model data) from two-dimensional (2D) video content (e.g., sports footage) and may render, in near-real time, 3D video content, which is transmitted to and displayed on an interface of an application executable by a user device. The 3D video content includes imagery that replays the scene captured in the 2D video content (e.g., a basketball player dunking a basketball, a football team scoring a goal, etc.) in a 3D format. In some examples, the 3D video content includes virtual reality (VR) content configured to be displayed on a 3D display (e.g., a VR wearable device). In some examples, the 3D video content includes augmented reality (AR) content configured to be displayed on a 2D display. The system includes a video manager that executes a technical process to increase the speed and/or accuracy of 3D production while reducing the amount of computing resources (e.g., memory, central processing unit (CPU) power, graphics processing unit (GPU) power, etc.) for enabling the display of 3D video content on a 2D display or a 3D display.

For example, the video manager may quickly and accurately generate a 3D video segment (e.g., 3D video highlight) from the 2D video content by obtaining 3D movement data of an object detected in the 2D video content from a 3D pose estimation engine, where the 3D movement data includes the position and orientation of the object in 3D space that captures the object's movement in 3D space. The video manager generates an animated object based on the 3D movement data in which the movement of the animated object corresponds to a movement of the object in the 2D video content. For example, the realistic movements captured by the 3D movement data are applied to a computer-generated object (e.g., the 3D object model), which converts a static model to a dynamic model that moves in the same/similar manner as the object in the 2D video content. The system may enable real-time rendering of the 3D video segment on user devices by using a streaming engine (e.g., a cloud-based 3D pixel streaming engine) that generates (e.g., renders) the 3D video content from the 3D video segment and re-generates (e.g., re-renders) the 3D video content according to any user selections, which may minimize, reduce, or eliminate the need for the user device to have specialized GPU equipment.

The video manager includes a 3D video generator configured to generate a 3D video segment (e.g., 3D model data) from the 2D video content. The 2D video content may be any type of 2D video content captured by a camera system. In some examples, the 2D video content is a video file or a portion of video content from a video file. In some examples, the 2D video content includes a video highlight from a sports event. However, it is noted that the system discussed herein is not limited to sport highlights, where the techniques discussed herein may be used for any type of 2D video content that has been captured from a camera system.

In some examples, a user may view the 2D video content using their user device and may initiate a 3D viewing request to view the 2D video content in a 3D format. For example, the interface may include a UI element, which, when selected, causes the 3D viewing request to be transmitted to the video manager. In response to the 3D viewing request, the 3D video generator may generate the 3D video segment (e.g., generates the 3D video segment on the fly or in near-real time). In some examples, in response to the 3D viewing request, the 3D video generator may obtain the 3D video segment (e.g., a previously generated 3D video segment) from a video database.

In some examples, the 2D video content includes television content (e.g., live television content), and the 3D video generator may generate one or more 3D video segments from one or more 2D video segments while the live television content is being broadcasted. In some examples, the 3D video generator identifies that the 2D video content includes a key event (e.g., a player makes a key play such as scoring a goal, etc.), selects a 2D video segment that includes the key event, and generates the 3D video segment from the 2D video segment. In some examples, the 3D video generator may receive 2D video segments during the course of the live broadcast from an external service, where the external service includes logic for selecting 2D video segments that include key events.

The 3D video generator may obtain 3D movement data (e.g., 3D pose data, 3D body positioning data) of a relevant object (or objects) detected in the 2D video content using machine-learning (ML) model(s). In some examples, the 3D video generator may obtain the 3D movement data from an existing (known) ML pose estimation model (e.g., 3D human pose estimation model and/or 3D object (e.g., ball) tracking model). The 3D movement data may include positional and rotational information that describes the movement and orientation of the object in 3D space. In some examples, the 3D video generator includes a ML human pose estimation model configured to detect the movement and orientation of a pose (e.g., represented by keypoints such as ankles, shoulder, neck, hands, etc.) of human objects in 3D space. In some examples, the 3D video generator includes an object detection and tracking model configured to detect the movement and orientation of a non-human object (e.g., a ball) in 2D space or 3D space. In some examples, the object detection and tracking model may provide a 2D position of the non-human object. In some examples, the object detection and tracking model may provide the height from the ground at each frame relative to the player.

The 3D video generator may generate an animated object using the 3D movement data and include the animated object in the 3D video segment. In some examples, the 3D video generator may generate an animated object by applying the 3D movement data to a 3D object model, which, in some examples, may represent the object. In some examples, the 3D video generator may select an existing 3D object model from an object model database (e.g., a model inventory) that corresponds to the detected object or may generate the 3D object model itself using the 2D video content using one or known mesh generation techniques. The operations executed by the 3D video generator may enable an animated object, depicted in the 3D video content, to have fluid and realistic movements that reflect the object's movement in the 2D video content. For example, if the object is a basketball player, the 3D video generator may generate 3D movement data about the player's movement in 3D space from the 2D video content. In some examples, the 3D generator may obtain (or generate) a 3D model object that represents the basketball player (which, may be a particular known basketball player, or a generic basketball player), and apply the 3D movement data to the 3D object model to generate an animated object, where the 3D object model is animated according to the player's movement.

The system may include a streaming engine configured to generate 3D video content from the 3D video segment. In some examples, the streaming engine is a 3D pixel streaming engine. The streaming engine may enable near real-time streaming and rendering of 3D graphics and interactive content over a network, which may include one or more rendering operations such as geometry processing, shading and material calculations, camera and viewpoint calculations, frame composition, video encoding, and/or network transmission. For example, the streaming engine includes one or more GPUs configured to execute the rendering operations on the 3D video segment to generate the imagery (e.g., the video frames) for the 3D video content. The streaming engine may transmit the 3D video content to a user device for display. In some examples, since the rendering operations are performed by the streaming engine, the 3D video content is transmitted to users without the need of a user device having special GPU hardware. The streaming engine may receive information indicating one or more user selections to user controls for adjusting and/or customizing the playback of the 3D video segment and may re-generate the 3D video content from the 3D video segment according to the user selection(s).

The interface may include one or more user controls that enable the user to modify a playback of the 3D video segment such as adjusting the viewing angle (e.g., selecting the point of view (POV) of the quarterback, selecting the POV of the ball, etc.), adding virtual content (e.g., animation effects, statistics, graphics, etc.), adjusting the viewing speed (e.g., slow down or speed up), modifying the animated object) (e.g., selecting a different model, modifying one or more characteristics of the object model). In some examples, the user may use the user controls to create customized 3D video content and use a share control to share the customized 3D video content with one or more other devices. In some examples, the interface includes a search field that receives a search query from the user and the interface may display search result(s) that identify one or more 3D video segments responsive to the search query. For example, a user may retrieve 3D highlights for a certain game, player, team, type of move, etc. These and other features are further explained with reference to the figures.

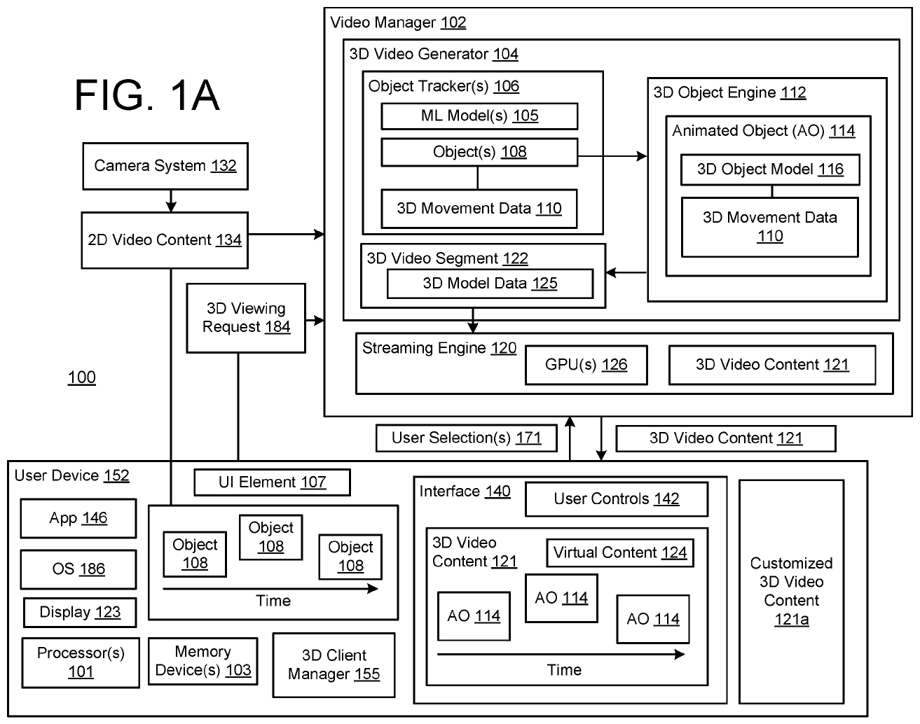

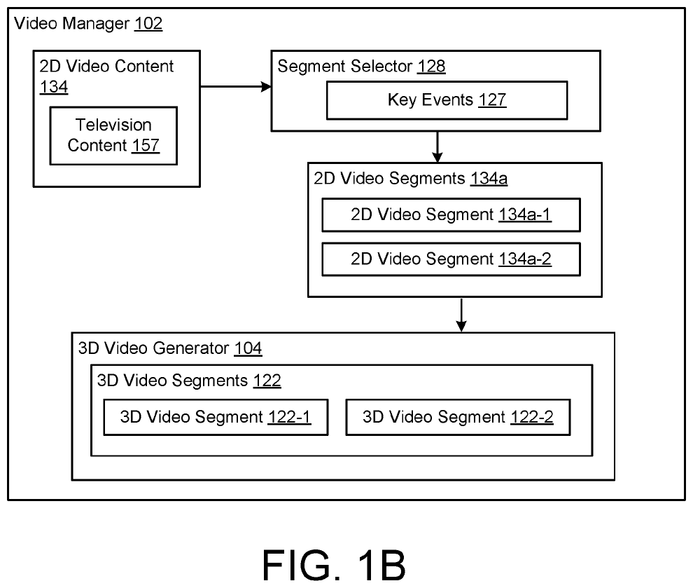

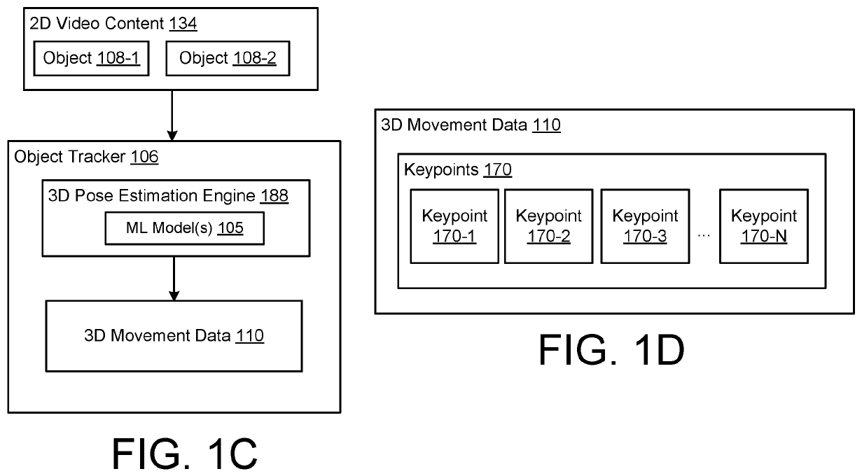

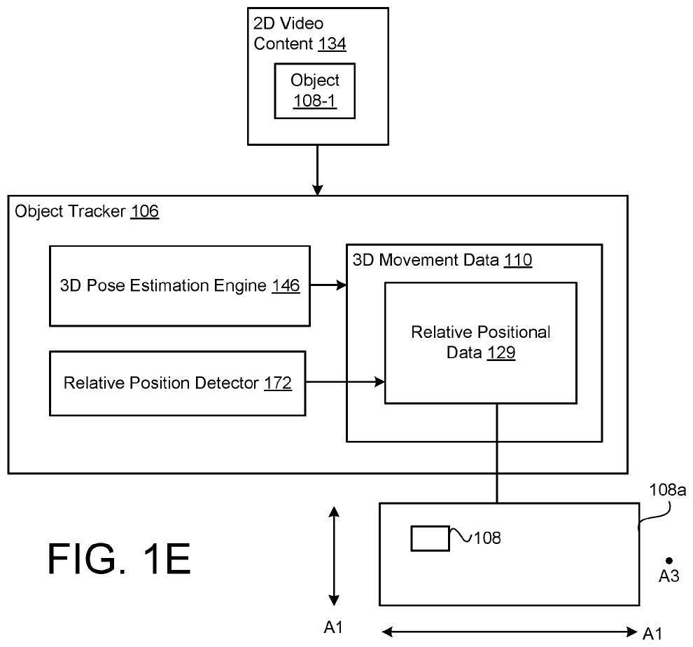

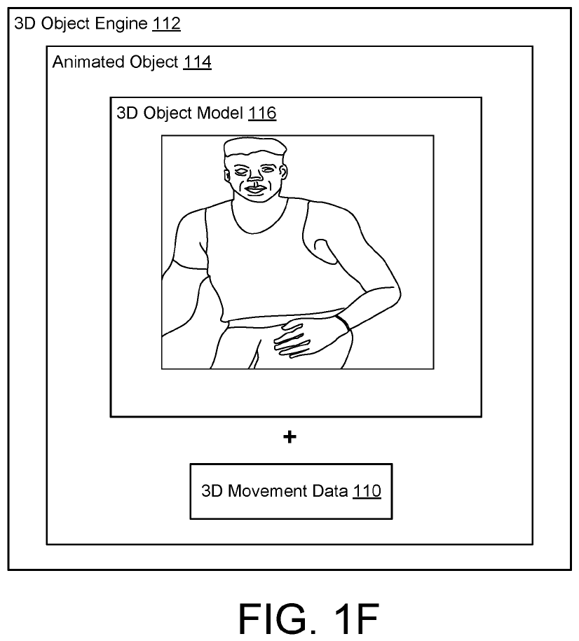

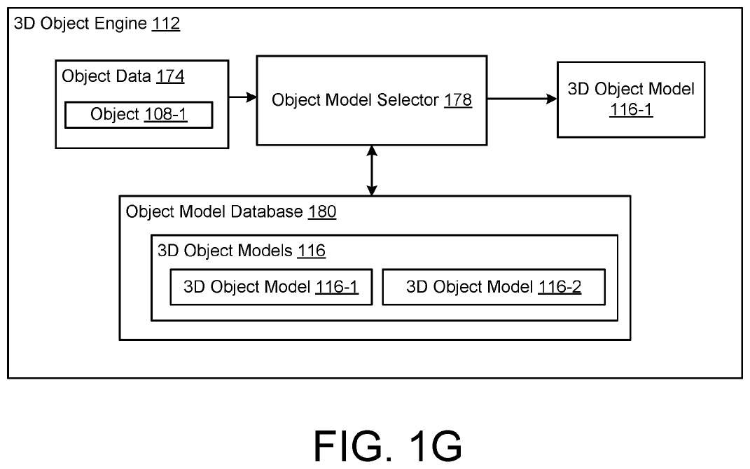

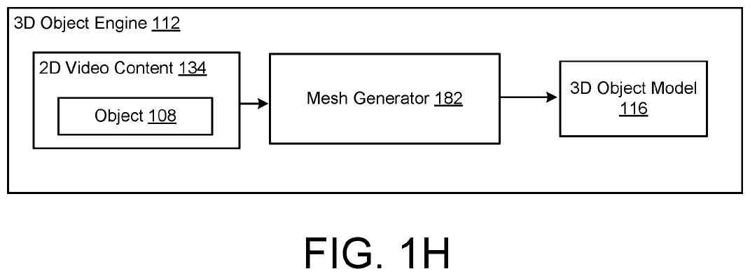

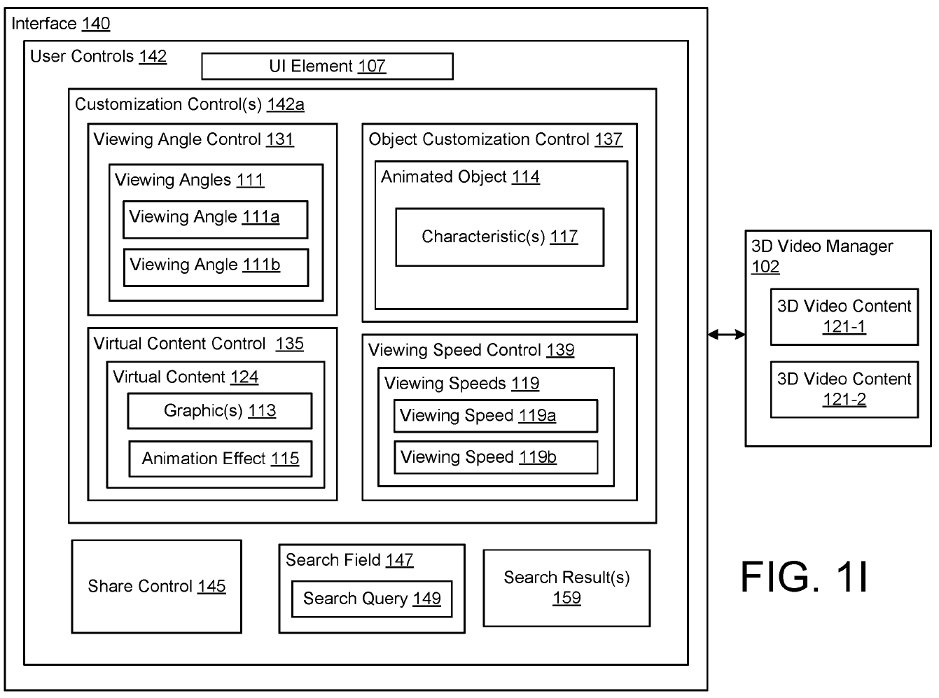

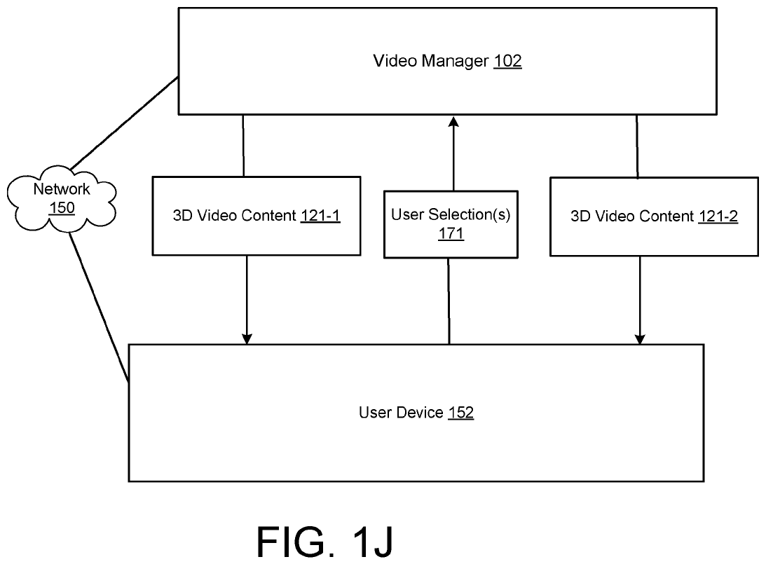

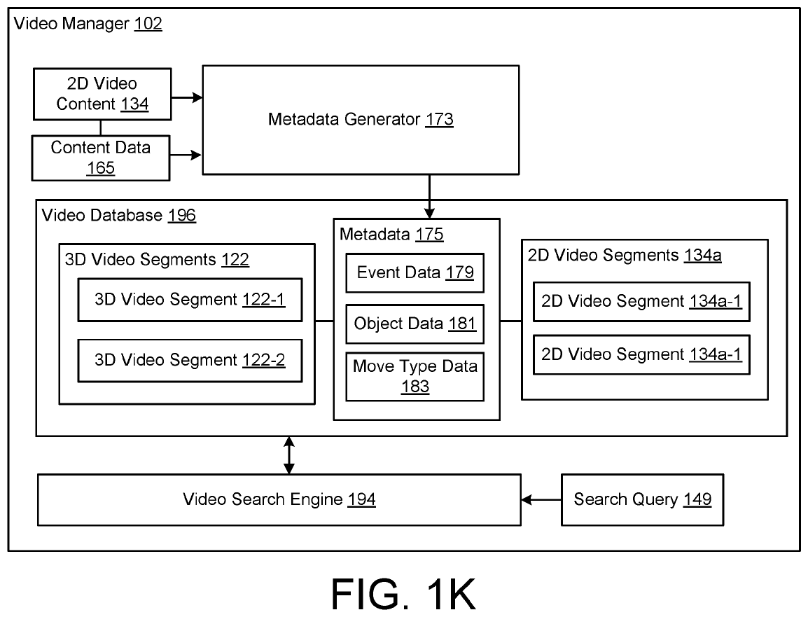

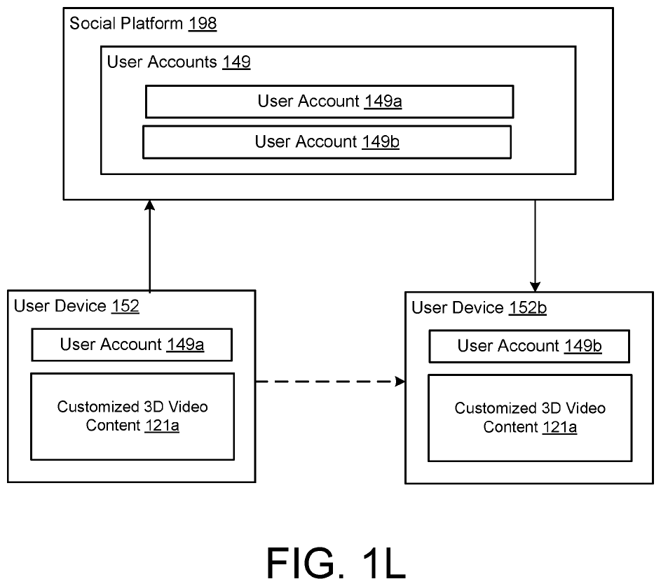

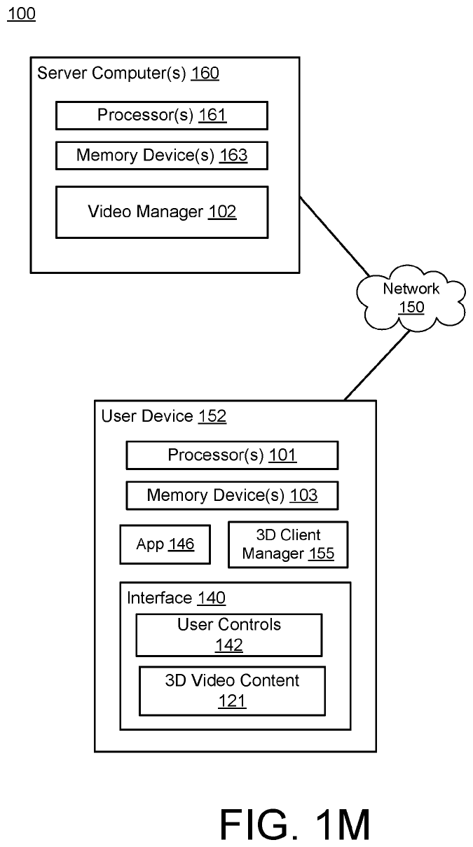

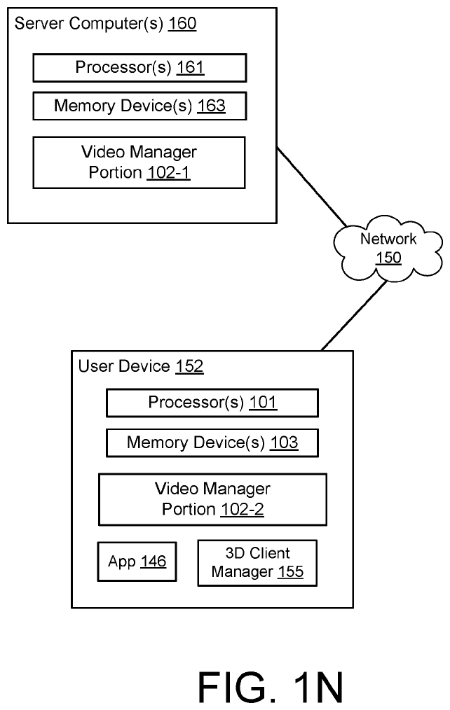

FIGS. 1A through 1N illustrate a system 100 for generating and distributing 3D video segments 122 to user devices 152 according to an aspect. The system 100 includes a video manager 102 configured to generate a 3D video segment 122 from 2D video content 134 using one or more machine-learning model(s) 105 and enabling 3D video content 121 generated from the 3D video segment 122 to be displayed in an interface 140 on a display 123 of a user device 152. The video manager 102 may implement technical features that can increase the speed and/or accuracy of 3D production while reducing the amount of computing resources (e.g., memory, central processing unit (CPU) resources, graphics processing unit (GPU) resources) for enabling the display of a 3D video segment 122 on a display 123, which may be 2D display or a 3D display.

For example, the video manager 102 may quickly and accurately generate a 3D video segment 122 (e.g., 3D video highlight) from the 2D video content 134 by obtaining 3D movement data 110 of an object 108 detected in the 2D video content 134 from a 3D pose estimation engine 188, where the 3D movement data 110 includes the position and orientation of the object 108 in 3D space that captures the object's movement in 3D space. The video manager 102 generates an animated object 114 based on the 3D movement data 110 in which the movement of the animated object 114 corresponds to a movement of the object 108 in the 2D video content 134. For example, the realistic movements captured by the 3D movement data 110 are applied to a computer-generated object (e.g., the 3D object model 116), which converts a static model to a dynamic model that moves in the same/similar manner as the object 108 in the 2D video content 134. The system 100 may enable real-time rendering of the 3D video segment 122 on user devices 152 by using a streaming engine 120 (e.g., a cloud-based 3D pixel streaming engine) that generates (e.g., renders) the 3D video content 121 from the 3D video segment 122 and re-generates (e.g., re-renders) the 3D video content 121 according to any user selections 171, which may minimize, reduce, or eliminate the need for the user devices 152 to have specialized GPU equipment.

The 3D video segment 122 includes 3D model data 125 that includes one or more animated objects 114 that move in a 3D scene in a manner that corresponds to the movement(s) of object(s) 108 in a 2D scene of the 2D video content 134. In some examples, an object 108 may be the structure of the object 108 (e.g., the body of a person or a non-human object such as a ball or other moveable object). The 3D video segment 122 may include other model data that defines one or more static structures and/or the environment of the 3D scene. In some examples, one or more machine-learning models 105 (e.g., a 3D pose estimation engine 188) may detect 3D movement data 110 about a movement and orientation of an object 108 in 3D space from the 2D positions of the object 108 in the frames of the 2D video content 134. The video manager 102 may generate an animated object 114 based on the 3D movement data 110. The animated object 114 may move in 3D space in a manner that corresponds to a movement of the object 108 in the 2D video content 134. In some examples, the video manager 102 may apply the 3D movement data 110 to a 3D object model 116, which creates an animated object 114 that moves in the 3D scene in a manner that corresponds to the movement of the object 108 in the 2D scene.

For example, the video manager 102 may detect 3D movement data 110 about a movement of the object 108 from the 2D video content 134. In some examples, the 3D movement data 110 is the 3D pose data over time. The 3D movement data 110 includes positional and rotational information that describes the movement and orientation of the object 108 in 3D space. In some examples, the 3D movement data 110 includes 3D positional coordinates (e.g., x, y, and z values) and rotation information (e.g., Euler angles, quaternions, and/or rotation matrices) of one or more keypoints 170 on the object 108 across a period of time. The keypoints 170 may represent different portions of the structure of the object 108, and the 3D movement data 110 may capture the movement and orientation of the keypoints 170 over time. The video manager 102 may generate an animated object 114 by applying the 3D movement data 110 to a 3D object model 116 that represents the object 108. In some examples, a 3D object model 116 is selected from an object model database 180 and the 3D movement data 110 is applied to the selected 3D object model 116. In some examples, the 3D object model 116 is generated from the 2D video content 134 using one or more known mesh generation techniques. The animated object 114 may move in the 3D scene in a manner that corresponds to the movement of the object 108 in the 2D scene.

The 3D video segment 122 may be a 3D video highlight (e.g., a 3D sports highlight). However, the techniques discussed herein may be applied to any type of underlying video content having one or more object 108 that move in 2D video content 134. The video manager 102 may convert a 2D video highlight to a 3D video highlight so that the user can replay the video highlight in a 3D format to enable the user to view the highlight from different angles and/or speeds and/or change aspects of the 3D video segment 122 such as adding graphics, statistics, and/or animation effects to the highlight, customizing the animated object(s) 114 (e.g., change the outfit, style, or other characteristics of the player, etc.) and/or customizing other portions of the 3D scene. For example, the 3D video segment 122 may be visually explored by the user based on user selections 171 received via one or more user controls 142 on the interface 140. The user may be able to view the highlight from different camera perspectives and/or speeds, as well as create customized 3D video content 121a (with graphics and/or animation effects), which can be shared with other users.

The video manager 102 includes a 3D video generator 104 configured to receive 2D video content 134 and generate a 3D video segment 122 based on the 2D video content 134. The 2D video content 134 includes video data (and, in some examples, audio data) captured from a camera system 132. The camera system 132 may include one or more camera devices configured to capture video in two dimensions, representing a scene as a flat image or a sequence of frames with height and width. Each frame of the 2D video content 134 includes a 2D array of pixels, where each pixel includes color and brightness information. In some examples, the camera system 132 includes an audio system having one or more microphones configured to capture audio data. In some examples, the camera system 132 does not include specialized capture equipment (e.g., stereoscopic cameras or depth-sensing technologies) to obtain additional depth information for a 3D experience. In some examples, the 2D video content 134 includes television content 157 (e.g., live television content).

The 2D video content 134 is displayed on the display 123 of the user device 152. In some examples, the display 123 is a 2D display. In some examples, the display 123 is a 3D display and the 2D video content 134 is displayed in the 3D display in a 2D format. In some examples, the 2D video content 134 is streamed to the user device 152 via a media platform (e.g., a streaming platform) while the camera system 132 is generating the 2D video content 134. In some examples, the 2D video content 134 is stored on a remote server computer and streamed to the user device 152 from the remote server computer. In some examples, the 2D video content 134 is stored on the user device 152.

An application 146, executable by the user device 152, may receive the 2D video content 134 and display the 2D video content 134 in the display 123. The application 146 may be a native application executable by an operating system 186 of the user device 152. In some examples, the application 146 is a streaming application. In some examples, the application 146 is a video sharing application. In some examples, the application 146 is a browser application. The browser application may render a webpage (or execute an application) in a browser tab that streams the 2D video content 134 to the user device 152 from a streaming platform (also referred to as a media platform or a media provider).

The 3D video generator 104 may obtain the 2D video content 134 from a streaming platform that distributes and/or stores the 2D video content 134 captured from the camera system 132. In some examples, the 3D video generator 104 may obtain the 2D video content 134 from the streaming platform while the camera system 132 is generating the 2D video content 134. In some examples, the 3D video generator 104 may receive the 2D video content 134 from a remote server computer that stores the 2D video content 134. In some examples, the 2D video content 134 is associated with a resource identifier (e.g., a uniform resource locator (URL)) that identifies a location of the 2D video content 134. In some examples, the 3D video generator 104 may retrieve the 2D video content 134 using the resource identifier. In some examples, the 3D video generator 104 may receive the resource identifier and/or the 2D video content 134 from the user device 152.

In some examples, the user may view the 2D video content 134 in an interface 140 of the application 146. The interface 140 may include a UI element 107 configured to enable the user to view the 2D video content 134 in a 3D format. In some examples, the UI element 107 is a UI control that enables the user to view the 2D highlight in a 3D format. In some examples, selection of the UI element 107 causes a 3D viewing request 184 to be generated and transmitted to the video manager 102. The 3D viewing request 184 may include information that identifies the 2D video content 134. In some examples, the 3D viewing request 184 includes the resource identifier of the 2D video content 134. In some examples, the 3D viewing request 184 may include the 2D video content 134.

In some examples, the application 146 may generate and transmit the 3D viewing request 184. In some examples, the user device 152 includes a 3D client manager 155 configured to generate and transmit the 3D viewing request 184. In some examples, the 3D client manager 155 is a program that is separate from the application 146. In some examples, the 3D client manager 155 is an operating system program. In some examples, the 3D client manager 155 is a component (e.g., a sub-component) of a browser application. The 3D client manager 155 and the application 146 may communicate with each other via an application programming interface (API) or an inter-process communication (IPC) link. In some examples, the 3D client manager 155 is configured to receive an indication of a user selection 171 to a user control 142, which may cause the 3D client manager 155 to generate and transmit the 3D viewing request 184. In some examples, the 3D client manager 155 is included as part of the application 146.

In response to the 3D viewing request 184, the 3D video generator 104 obtains the 2D video content 134 and generates the 3D video segment 122. In some examples, the 3D video generator 104 may generate a single 3D video segment 122 from the 2D video content 134. In some examples, the 3D video generator 104 may generate multiple 3D video segments 122 from the 2D video content 134. In some examples, the 3D video generator 104 may retrieve the 2D video content 134 using the resource identifier of the 2D video content 134. In some examples, the 3D video generator 104 may obtain the 2D video content 134 from the 3D viewing request 184. In some examples, the video manager 102 may use the information from the 3D viewing request 184 to determine whether or not a 3D video segment 122 has already been generated for the 2D video content 134. For example, the video manager 102 may query a video database 196 that stores a plurality of 3D video segments 122 (e.g., using the resource identifier, another identifier that can uniquely identify with the 2D video content 134, and/or other information included in the 3D viewing request 184). If the video manager 102 determines that a 3D video segment 122 has not been generated from the 2D video content 134, the video manager 102 may cause the 3D video generator 104 to generate the 3D video segment 122.

In some examples, the 3D video generator 104 may generate one or more 3D video segments 122 from the 2D video content 134 without prompting from the user. As shown in FIG. 1B, the video manager 102 may include a segment selector 128 configured to identify one or more 2D video segments 134a from the 2D video content 134. A 2D video segment 134a may be an example of the 2D video content 134. In some examples, a 2D video segment 134a is a shorter video clip (e.g., a highlight) from the longer video content (e.g., the 2D video content 134). The 2D video content 134 may include television content 157. Television content 157 may be a program associated with a television channel. The program may be a sports program. In some examples, a media platform (or media provider) is configured to stream the television content 157 over a network 150 and/or broadcast the television content 157 using radio waves. In some examples, the television content 157 includes live television content. Live television content may be digital data that is streamed or broadcasted as the 2D video content 134 is captured by the camera system 132.

The segment selector 128 detects that a portion of the television content 157 includes a key event 127 and identifies a 2D video segment 134a from the portion of the television content 157. For example, the segment selector 128 may receive the television content 157 as the television content 157 is captured by the camera system 132 and is streamed/broadcasted to viewers. The segment selector 128 may detect whether the 2D video content 134 includes a key event 127, and, if so, may identify a 2D video segment 134a. A key event 127 may be a specific sports action or event (e.g., a goal, foul, pass, etc.). In response to detecting a key event 127 in the 2D video content 134, the segment selector 128 may determine the beginning and end of the scene and select that portion for the 2D video segment 134a. A 2D video segment 134a may be a clip or portion of the television content 157 that contains a highlight (e.g., the key event 127). The 2D video segment 134a may include a key play from the sports event. The 2D video segment 134a may be a video clip of a basketball player dunking a basketball or a football player scoring a goal.

The segment selector 128 executes one or more existing event detection algorithms to analyze the video footage of the television content 157 to determine whether the 2D video content 134 depicts a key event 127, and, if so, may identify a 2D video segment 134a as a highlight for the 2D video content 134.

The segment selector 128 may include an event recognition model (e.g., convolution neural networks (CNNs) or recurrent neural networks (RRNs)) configured to (e.g., trained to) to recognize a key event 127 in one or more types of sporting events. For basketball, the segment selector 128 detects a key event 127 when a player has scored a basketball, performed a certain action like dunking a basketball, made an assist, made a steal, etc. For football, the segment selector 128 may detect a key event 127 for a player that caught the ball over a threshold number of yards, scored a touchdown, etc. In some examples, the segment selector 128 includes a motion analysis model configured to analyze motion patterns of detected objects (e.g., objects 108 detected by the object tracker(s) 106) to detect a key event 127 (e.g., key movement) in the 2D video content 134. Techniques like optical flow, which estimates the motion of pixels between consecutive frames, may be used to calculate the magnitude and direction of motion for each object 108. Changes in motion, sudden accelerations, or specific movement patterns may indicate a key event 127. In some examples, the segment selector 128 includes a rule-based model that analyzes the 2D video content 134 to apply specific rules or criteria for detecting a key event 127. For example, in basketball, detecting slam dunks or three-point shots can be based on height, ball trajectory, and shot location. By defining rules or thresholds based on the sport's rules, the segment selector 128 may detect a key event 127 in the 2D video content 134.

As shown in FIG. 1B, the segment selector 128 may identify a 2D video segment 134a-1 and a 2D video segment 134a-2 from the 2D video content 134. Then, the 3D video generator 104 may generate a 3D video segment 122-1 corresponding to the 2D video segment 134a-1 and a 3D video segment 122-2 corresponding to the 2D video segment 134a-2. Although two 3D video segments 122 are depicted in FIG. 1G, the 3D video generator 104 may generate any number of 3D video segments 122 from the television content 157, which may depend on the number of key events 127 that are detected in the 2D video content 134.

Referring back to FIG. 1A, the 3D video generator 104 may include one or more object trackers 106 configured to detect one or more types of objects 108 in the 2D video content 134 and generate 3D movement data 110 for the object(s) 108 detected in the 2D video content 134. In some examples, the object tracker(s) 106 includes a separate object tracker 106 configured to detect an object 108 of a certain type (or classification) and generate 3D movement data 110 for that type of object 108, where the 3D movement data 110 may be different across different types of objects 108. In some examples, a single object tracker 106 may detect multiple different types of objects 108 and generate 3D movement data 110 for the different types of objects 108. In some examples, a first object tracker is configured to generate 3D movement data 110 for one or more types of objects 108 (e.g., a player), and a second object tracker is configured to generate 2D movement data for one or more types of objects 108 (e.g., a ball).

In some examples, the object tracker 106 includes a 3D pose estimation engine 188 for human or non-human pose detection. In some examples, the 3D pose estimation engine 188 includes an existing 3D pose estimation model (e.g., Embody model, PyMAF model). The 3D movement data 110 may include positional and rotational information that describes the movement and orientation of the object 108 in 3D space. In some examples, the 3D pose estimation engine 188 includes a ML human pose estimation model configured to detect the movement and orientation of a pose (e.g., represented by keypoints 170 such as ankles, shoulder, neck, hands, etc.) of human objects in 3D space. In some examples, the object tracker 106 includes an object detection and tracking model configured to detect the movement and orientation of a non-human object (e.g., a ball) in 2D space or 3D space. In some examples, the object detection and tracking model may provide a 2D position of the non-human object. In some examples, the object detection and tracking model may provide the height of the ground from the ground at each frame relative to the player.

As shown in FIG. 1C, the 2D video content 134 may visually depict an object 108-1 and an object 108-2 in the frames of the 2D video content 134. In some examples, the object 108-1 is a person. In some examples, the object 108-2 is a non-human object such as a ball. Although FIG. 1C depicts two objects 108 in the 2D video content 134, the object tracker(s) 106 may detect and generate 3D movement data 110 for any number of (or types of) objects 108 in the 2D video content 134, including one object 108 or any number of objects 108 greater than two. The objects 108 may represent various physical objects such as players, a ball, and/or other physical elements depicted in the 2D video content 134.

In some examples, an object tracker 106 may detect that the object 108-1 is an object 108 of a first type (e.g., the object 108-1 has a human body), and may generate 3D movement data 110 from the 3D video content 134. In some examples, the object tracker 106 may detect further sub-types of the first type, such as whether the person is a player or a non-player (e.g., a coach or referee, training staff, etc.), whether the person is a particular type of player (e.g., guard, center, lineman, receiver, quarterback) and/or whether the person is a known entity (e.g., a particular person such as Khris Middleton, Jrue Holiday, Jordan Love, etc.). In some examples, the object tracker 106 (or, in some examples, another object tracker) may detect that object 108-2 is an object 108 of a second type (e.g., a ball), and may generate 3D movement data 110 from the 2D video content 134. In some examples, the object tracker 106 (or other object trackers) may detect other types of objects 108 and generate 3D movement data 110 from the 2D video content 134.

The object tracker 106 includes a 3D pose estimation engine 188 configured to generate the 3D movement data 110 for an object 108 (e.g., object 108-1, object 108-2) detected in the 2D video content 134. The 3D pose estimation engine 188 may include one or more machine learning (ML) models 105. In some examples, the 3D movement data 110 is the 3D pose of the object 108 over time. The 3D movement data 110 includes positional and rotational information that describes the movement and orientation of the object 108 in 3D space. In some examples, the 3D movement data 110 includes 3D positional coordinates (e.g., x, y, and z values) and rotation information (e.g., Euler angles, quaternions, and/or rotation matrices) of at least one of a plurality of keypoints 170 across a period of time. The keypoints 170 may represent different portions of the structure of the object 108.

As shown in FIG. 1D, the object 108 may be defined by one or a set of keypoints 170 whose 3D positions and orientation are estimated by the 3D pose estimation engine 188. The keypoints 170 may relate to different parts of the object 108 (e.g., for a human body, the parts may be ankles, hips, head, shoulders, elbows, etc.). The keypoints 170 may include a keypoint 170-1, a keypoint 170-2, and a keypoint 170-3 through keypoint 170-N. It is noted that the 3D pose estimation engine 188 may track a single keypoint 170 (e.g., a central point on the object 108) or multiple keypoints 170 such as any number greater or equal to two.

The 3D pose estimation engine 188 generates the 3D movement data 110 by estimating the 3D locations of the keypoints 170 from the 2D locations of the keypoints 170 in the 2D video content 134. The keypoints 170 may include parts that form the pose. In some examples, for a human body, the keypoints 170 may include head, neck, right shoulder, left shoulder, right elbow, left elbow, right wrist, left wrist, right hip, left hip, right knee, left knee, right angle, and/or left ankle. In some examples, the keypoints 170 include nose, left eye, and/or right eye. The 3D location of a keypoint 170 may refer to the 3D spatial position (e.g., positional coordinates (e.g., X, Y, Z values)) of the keypoint 170 in 3D space, and, in some examples, rotation information about an orientation of a keypoint 170 in 3D space. In some examples, the rotation information may include euler angles, quaternions, and/or rotation matrices.

In some examples, the 3D pose estimation engine 188 estimates the 2D pose of the object 108 (e.g., person) in the input data (e.g., the 2D video content 134). 2D pose estimation involves detecting and localizing the keypoints 170 (e.g., key body joints) in each frame of the input data. This can be achieved using various techniques, such as convolutional neural networks (CNNs) or pose estimation algorithms based on graphical models. In some examples, the 3D pose estimation engine 188 may estimate depth for the keypoints 170 using the 2D pose, which may include triangulating the 2D positions of the keypoints 170 from multiple camera views or utilizing depth maps to infer the depth information. Once the 2D positions and depth information (if available) are obtained, 3D pose estimation engine 188 may perform 3D pose estimation. There are different approaches for 3D pose estimation, including model-based methods, direct regression methods, and learning-based methods.

In some examples, the 3D movement data 110 generated by the 3D pose estimation engine 188 may not include positions of the object(s) 108 relative to a static structure in the 2D video content 134 (e.g., the players' position on the court or field). As shown in FIG. 1E, the object tracker 106 may include a relative position detector 172 configured to generate relative positional information 129 about a position of an object 108 (e.g., one or more keypoints 170 of the object 108) with respect to one or more static structures 108a representing a physical structure (e.g., a court, field, goal, etc.) in the 2D video content 134. In some examples, the relative position detector 172 may control one or more aspects of the 3D pose estimation engine 188 to compute the 3D movement data 110 at one or more times when one or more keypoints 170 of the object 108 contacts portion(s) of the static structure(s) 108a or select a portion of the 3D movement data 110 at one or more times when one or more keypoints 170 of the object 108 contacts portion(s) of the static structure(s) 108a.

The static structure 108a represents a physical space having a surface defined by a width (in a direction A1) and length (in a direction A2), and, in some examples, a height defined in an orthogonal direction (a direction A3 depicted as a dot that extends into and out of the page) from the surface. The relative positional information 129 may include the 3D position of the object 108-1 relative to another object, i.e., the static structure 108a.

The relative position detector 172 may detect the static structure 108a from the 2D video content 134 and may calculate, over time, a position (e.g., 3D position) of the object 108 relative to the static structure 108a from the 2D video content 134. In some examples, the relative position detector 172 may use an inverse kinematics (IK) technique to compute the object's position relative to the static structure 108a from the video frames of the 2D video content 134. In some examples, the relative position detector 172 may use an IK technique to compute the object's position relative to the static structure 108a at one or more key events (e.g., each foot's position on the court when the player's foot touches the ground in the 2D video content 134, a beginning and/or end times and locations of any jumps, when the ball changes hands, and is released). In some examples, the relative position detector 172 may use a camera calibration tool and camera parameters from the camera system 132 to compute the position of the object 108 relative to the static structure 108a from the video frames of the 2D video content 134.

Referring back to FIG. 1A, the 3D video generator 104 includes a 3D object engine 112 configured to generate an animated object 114 using the 3D movement data 110. In some examples, the 3D object engine 112 may apply the 3D movement data 110 to a 3D object model 116 that represents a 3D version of the object 108. In some examples, the 3D object model 116 does not represent the object 108 but represents the user of the user device 152. In some examples, the 3D object model 116 may be any type of computer-generated object configured to be enhanced with the 3D movement data 110. In some examples, If the object 108 is a basketball player, the 3D object model 116 is a model representation of a basketball player.

The 3D object model 116 may include information about the geometry, topology, and appearance of a 3D object. The 3D object model 116 may define the shape and structure of the 3D object, and may include information about vertices, edges, and/or faces that form the object's surfaces. The 3D object model 116 may include information about the connectivity and relationships between the geometric elements of the model, and may define how the vertices, edges, and faces are connected to form the object's structure. The 3D object model 116 may include texture coordinates that define how textures or images are mapped into the surfaces of the model and may provide a correspondence between the points on the 3D surface and the pixels in a 2D texture image. In some examples, the 3D object model 116 may include information about normals (e.g., vectors perpendicular to the surface at each vertex or face) that determine the orientation and direction of the surfaces, indicating how light interacts with the surface during shading calculating. The 3D object model 116 may include information about material properties that describe the visual appearance and characteristics of the 3D object's surfaces, and may include information such as color, reflectivity, transparency, shininess, and other parameters that affect how the surface interacts with light.

In some examples, the 3D object model 116 is initially configured as a static model. However, when the 3D object engine 112 applies the 3D movement data 110 from the object tracker(s) 106, the static model is transformed into an animated object 114, thereby producing a dynamic object. In some examples, the animated object 114 may be referred to as an animated mesh or animated rig. Applying the 3D movement data 110 to the 3D object model 116 may include adding the 3D movement data 110 to the 3D object model 116 to generate an animated object 114 in which the 3D object model 116 is configured to move in a manner as indicated by the 3D movement data 110.

In other words, as shown in FIG. 1F, the animated object 114 is defined by the 3D object model 116, which is augmented with the 3D movement data 110 generated by the 3D pose estimation engine 188. The animated object 114 is configured to have a 3D pose in the video frames of the 3D video content 121 that correspond to the pose in the video frames of the 2D video content 134, thereby reproducing the object's movement in 3D. The animated object 114 may also include any of the information discussed with reference to the 3D object model 116.

In some examples, the 3D object engine 112 selects a 3D object model 116 to represent the object 108 detected in the 2D video content 134. As shown in FIG. 1G, the 3D object engine 112 may include an object model selector 178. For an object 108-1 detected in the 2D video content 134, the object model selector 178 may select a 3D object model 116-1 that represents the object 108 from an object model database 180 that stores a plurality of 3D object models 116. The object model database 180 may be referred to as a 3D object model inventory. The 3D object models 116 stored in the object model database 180 may be different versions of a 3D model. The 3D object models 116 stored in the object model database 180 may include a 3D object model 116-1 and a 3D object model 116-2. The 3D object model 116-2 may have at least one characteristic that is different from the 3D object model 116-1. However, the 3D object models 116 stored in the object model database 180 may include any number of 3D models (e.g., ranging from tens, to hundreds, to thousands). In some examples, the object model selector 178 may select one of the 3D object models 116 stored in the object model database 180 based on object data 174 associated with the object 108-1.

In some examples, the object data 174 includes information detected by an object tracker 106 such as the classification type, e.g., whether the object 108 is a player or a non-player, a particular type of player, and/or a particular known player. In some examples, if the object data 174 indicates that the object 108 is a player, the object model selector 178 may obtain an object model 116-1 that represents a generic player. In some examples, if the object data 174 indicates that the object 108 is a particular type of player (e.g., a receiver, running back, center, or guide), the object model selector 178 may obtain an object model 116-1 that represents the particular type of player. In some examples, if the object data 174 indicates that the object 108 is a particular known player (e.g., Kris Middleton), the object model selector 178 may obtain an object model 116-1 that represents the particular known player.

In some examples, the 3D object engine 112 uses the video footage of the object 108 in the 2D video content 134 to generate the 3D object model 116. For example, as shown in FIG. 1I, the 3D object engine 112 may include a mesh generator 182 configured to receive the 2D video content 134 that includes the object 108 and generate the 3D object model 116 to have characteristics that mimic the object's characteristics in the 2D video content 134. The mesh generator 182 may use one or more existing 3D reconstructions techniques to create the 3D object model 116 from the 2D video content 134. In some examples, the 3D object model 116 includes a 3D mesh that represents the structure of the object 108.

In some examples, the mesh generator 182 may obtain or determine the intrinsic parameters of the camera system 132, such as focal length, principal point, and lens distortion. This information may be used to accurately project the 3D geometry into the 2D image coordinates. In order to reconstruct the 3D geometry, the mesh generator 182 may extract the features or keypoints from the 2D video frames. These features can be points, edges, corners, or other distinctive elements. Feature tracking algorithms are used to match corresponding features across different frames, allowing the tracking of their movement over time. In some examples, the mesh generator 182 may include one or more structure-from-motion (SfM) techniques. SfM is a technique used to estimate the camera poses and reconstruct the 3D structure of the scene from a set of 2D images. It utilizes the tracked features and camera calibration information to determine the camera positions and orientations at different time instants. SfM algorithms estimate the 3D structure by triangulating the corresponding feature points from multiple camera viewpoints.

Once the initial sparse 3D structure is estimated, the mesh generator 182 may refine the initial sparse 3D structure using dense reconstruction techniques. Dense reconstruction may reconstruct the 3D geometry of the object 108 at a higher level of detail by estimating the depth values for pixels (e.g., every pixel) in the 2D video frames. Techniques such as depth mapping, stereo matching, or structure-from-motion refinement may be employed for dense reconstruction. After obtaining a dense point cloud representing the 3D structure of the object, the mesh generator 182 may generate a 3D mesh that represents the object's surface. Surface reconstruction techniques, such as Delaunay triangulation or Poisson surface reconstruction, may be applied to convert the point cloud into a mesh representation. These algorithms create a set of connected triangles that approximate the object's surface geometry. Depending on the quality and accuracy of the initial mesh, additional refinement steps may be required. Mesh refinement techniques, such as smoothing, regularization, or texture mapping, can be applied to improve the mesh's visual quality, remove noise, and align it more closely with the object's true geometry.

Referring back to FIG. 1A, the 3D video segment 122 includes an animated object 114 (e.g., defined by the 3D object model 116 augmented with the 3D movement data 110) for one or more objects 108 detected in the 2D video content 134. In some examples, the 3D video segment 122 includes an animated object 114 for a single object 108 (e.g., single player) detected in the 2D video content 134. In some examples, the 3D video segment 122 includes multiple animated objects 114 for multiple objects 108 (e.g., multiple players) detected in the 2D video content 134. The 3D video segment 122 may include other computer-generated model objects and content that represent the 3D scene. For example, if the 3D scene relates to a basketball event, the 3D video generator 104 may generate the 3D video segment 122 to include other computer-generated model objects (e.g., static and/or animated models) that represent other objects in the 3D scene such the court (e.g., an outside basketball court, a basketball within an arena within an area), the hoop, the fans, lighting and shading that indicate time of day (e.g., nighttime or daytime), etc.

The video manager 102 system may include a streaming engine 120 configured to generate 3D video content 121 from the 3D video segment 122. In some examples, the streaming engine 120 renders video frames from the 3D video segment 122, where the 3D video content 121 includes the rendered video frames. In some examples, the streaming engine 120 encodes and compresses the rendered video frames, where the 3D video content 121 is a video stream having the encoded and compressed video frames.

The streaming engine 120 may enable near real-time streaming and rendering of 3D graphics and interactive content over a network 150, which may include one or more rendering operations such as geometry processing, shading and material calculations, camera and viewpoint calculations, frame composition, video encoding, and/or network transmission. For example, the streaming engine 120 includes one or more GPUs 126 configured to execute the rendering operations on the 3D video segment 122 to generate the imagery (e.g., the video frames) for the 3D video content 121. The streaming engine 120 may transmit the 3D video content 121 to a user device 152 for display. In some examples, since the rendering operations are performed by the streaming engine 120, the 3D video content 121 is transmitted to users without the need of a user device having special GPU hardware. In some examples, the 3D video segment 122 is a video stream.

In some examples, the application 146 receives the 3D video content 121, decodes the 3D video content 121, and displays the 3D video content 121 in the interface 140 of the application 146. In some examples, the 3D client manager 155 receives the 3D video content 121, decodes the 3D video content 121, and provides the decoded (rendered) video frames to the application 146 for display on the interface 140. In some examples, the 3D client manager 155 is a program configured to operate as an intermediary between the application 146 and the video manager 102. In this manner, the 3D client manager 155 may execute the operations associated with communicating with the video manager 102 and the decoding of the 3D video content 121, which may improve the performance of the application 146.

The streaming engine 120 may receive information indicating one or more user selections 171 to one or more user controls 140 for adjusting and/or customizing the playback of the 3D video segment 122, and the streaming engine 120 may re-generate the 3D video content 121 from the 3D video segment 122 according to the user selection(s) 171. The streaming engine 120 may transmit 3D video content 121-1 to the user device 152 for display in the interface 140. The interface 140 may include one or more user controls 142 that enable the user to view, modify, and share the playback of the 3D video segment 122. In response to a user selection 171 to a user control 142, the streaming engine 120 may receive information about the user selection 171, generate 3D video content 121-2 from the 3D video segment 122 according to the user selection 171, and transmit the 3D video content 121-2 to the user device 152 for display in the interface 140.

As shown in FIGS. 1I and 1J, the user controls 142 may include one or more customization controls 142a that may modify the playback of the 3D video segment 122. The customization controls 142a may include a viewing angle control 131 configured to enable the user to adjust a viewing angle 111 of the 3D video segment 122. The viewing angle control 131 may provide a plurality of viewing angles 111 including a viewing angle 111a and a viewing angle 111b. Although two viewing angles 111 are shown in FIG. 1I, it is noted that the 3D video segment 122 may be replayed from many viewing angles 111 (including all viewing angles 111). In some examples, the viewing angles 111 include a predefined set of viewing angles 111.

The customization controls 142a may include a virtual content control 135 configured to enable the user to add virtual content 124 to the playback of the 3D video segment 122. For example, the virtual content control 135 may enable the user to add one or more graphics 113 to the 3D video segment 122. The graphics 113 may include statistics and other graphics associated with the 3D scene (e.g., how fast a player is traveling, how high a player has jumped, the number of yards of a passing play, etc.). In some examples, the virtual content control 135 may enable the user to add animation effect 115 to the 3D scene.

The customization controls 142a may include an object customization control 137 configured to enable the user to modify one or more characteristics 117 of an animated object 114. For example, the user may use the object customization control 137 to change certain aspects of the 3D object model 116 (e.g., change the outfit or other attributes of the underlying avatar) or use a different 3D object model 116 (e.g., use a different avatar). The customization controls 142a may include a viewing speed control 139 configured to enable the user to adjust a viewing speed 119 of the 3D video segment 122. The viewing speed control 139 may provide a plurality of viewing speeds 119 including a viewing angle 119a and a viewing angle 119b. Although two viewing speeds 119 are shown in FIG. 1I, it is noted that the 3D video segment 122 may be replayed from many viewing speeds 119. In some examples, the viewing speeds 119 include a predefined set of viewing speeds 119.

In some examples, the interface 140 includes a search field 147 that enables the user to submit a search query 149 from the user, and, in response to the submission of the search query 149, the interface 140 may display search results 159 that identify one or more 3D video segments 122 responsive to the search query 149. For example, a user may retrieve 3D highlights for a certain game, player, team, type of move, etc.

For example, as shown in FIG. 1K, the video manager 102 may include a metadata generator 173. The metadata generator 173 may receive content data 165 about a 2D video content 134 and generate (and/or associate) metadata 175 with a 3D video segment 122. The metadata generator 173 may generate the metadata 175 about the 2D video content 134 and store the metadata 175 within the 3D video segment 122 in the video database 196. In some examples, the metadata generator 173 may generate the metadata 175 when the 3D video generator 104 generates the 3D video segment 122. In some examples, the metadata generator 173 may also associate the 3D video segment 122 with the corresponding 2D video segment 134a, which was used to generate the 3D video segment 122. In some examples, the 3D video segment 122 includes an identifier (e.g., a resource identifier or other identifier) that identifies the location of the 2D video segment 134a that was used to generate the 3D video segment 122. In some examples, a 2D video segment 134a includes an identifier (e.g., a resource identifier or other identifier) that identifies the location of the corresponding 3D video segment 122.

The content data 165 may include information associated with the 2D video content 134 such as the title, location, time, the teams, key players, a description of the underlying event and/or any metadata that is included as part of the 2D video content 134. In some examples, the content data 165 may include any information detected from the object tracker(s) 106. The metadata 175 may include event data 179 about the time, location, duration, teams, record, key players, and/or any information about the underlying event. The metadata 175 may include object data 181 about the objects 108 detected by the object trackers 106. For example, the object data 181 may identify particular players or information about the players. In some examples, the metadata 175 includes move type data 183 that classifies a particular movement of an object 108. For example, the object tracker 106 may be able to classify certain player movements as pertaining to a known sports move (e.g., a 360 degree dunk, or windmill dunk, etc.).

As shown in FIG. 1K, the video database 196 may store a 3D video segment 122-1 and the video database 196 may store the metadata 175 generated by the metadata generator 173 that is associated with the 3D video segment 122-1. In some examples, the video database 196 also associates a 2D video segment 134a-1 with the 3D video segment 122-1, where the 2D video segment 134a-1 was used to generate the 3D video segment 122-1. The video database 196 may store a 3D video segment 122-2 and the video database 196 may store the metadata 175 generated by the metadata generator 173 that is associated with the 3D video segment 122-2. In some examples, the video database 196 also associates a 2D video segment 134a-2 with the 3D video segment 122-2, where the 2D video segment 134a-2 was used to generate the 3D video segment 122-2.

The video manager 102 may include a video search engine 194. The video search engine 194 may receive the search query 149 from the user device 152 and the term(s) included in the search query 149 to search the metadata 175 to identify one or more 3D video segments 122 in the video database 196 that are responsive to the search query 149. The video search engine 194 may provide search result(s) 159 that identifies the 3D video segments 122 responsive to the search query 149. In some examples, the search result(s) 159 may also identify a 2D video segment 134a for a corresponding 3D video segment 122 included in the search result(s) 159. In this manner, a user may view the original 2D footage and explore the highlight in the 3D format.

In some examples, referring to FIGS. II and IL, the interface 140 may include a share control 145 configured to enable the user to share customized 3D video content 121a with one or more other users (e.g., a user device 152b). The user may use the user controls 142 to modify aspects of the 3D video segment 122 to create customized 3D video content 121a and use the share control 145 to transmit the customized 3D video content 121a to the user device 152b. In some examples, the user-customized 3D video content 121a is stored at the video manager 102, and the user may create a message with a resource identifier (e.g., a selectable URL link) that identifies the location of the customized 3D video content 121a, and the message can be transmitted to the user device 152b. In some examples, the user device 152 may share the customized 3D video content 121a with other users by posting a message that identifies the customized 3D video content 121a to a social platform 198. In some examples, the user device 152 is associated with a user account 149a of the social platform 198, and the user device 152b is associated with a user account 149b of the social platform 198. In some examples, a user may use the user device 152b to discover the message with the customized 3D video content 121a on the social platform 198.

Referring to FIG. 1M, in some examples, the video manager 102 is executable by one or more server computer(s) 160. The server computer(s) 160 may include one or more processor(s) 161 and one or more memory device(s) 163.

As shown in FIG. 1M, the user device 152 may include the application 146 and the 3D client manager 155. The user device 152 may include one or more processor(s) 101 and one or more memory devices 103. In some examples, the 3D client manager 155 is configured to communicate with the application 146 to detect a user selection 171 to one or more user controls 142 and transmit information about the user selection 171 to the video manager 102. The 3D client manager 155 may receive the 3D video content 121 from the video manager 102, decode the 3D video content 121, and provide the 3D video content 121 to the application 146. In some examples, the 3D client manager 155 is a component that is part of the application 146. In some examples, the 3D client manager 155 is a component that is separate from the application 146. In some examples, the 3D client manager 155 is a component of the operating system 186 or a browser application.

As shown in FIG. 1N, in some examples, a video manager portion 102-1 is executable by the server computer(s) 160, a video manager portion 102-2 is executable by the user device 152. For example, some of the operations of the video manager 102 may be executable by the server computer(s) 160 and some of the operations of the video manager 102 may be executable by the user device 152. In some examples, the video manager portion 102-1 includes the 3D video generator 104, and the video manager portion 102-2 includes the streaming engine 120. In some examples, the video manager portion 102-1 includes the object tracker(s) 106 and the 3D object engine 112. In some examples, the video manager portion 102-1 includes the object tracker(s) 106, and the video manager portion 102-2 includes the 3D object engine 112.

The user device 152 may be any type of computing device that includes one or more processors 101, one or more memory devices 103, a display 123, and an operating system 186 configured to execute (or assist with executing) one or more applications (including application 146). In some examples, the display 123 is a 2D display. In some examples, the display 123 is a 3D display. In some examples, the operating system 186 is the application 146. In some examples, the application 146 is an application executable by the operating system 186. In some examples, the user device 152 is a laptop computer. In some examples, the user device 152 is a desktop computer. In some examples, the user device 152 is a tablet computer. In some examples, the user device 152 is a smartphone. In some examples, the user device 152 is a wearable device. In some examples, the user device 152 is a virtual reality (VR) device (which may include a headset). In some examples, the user device 152 is an augmented reality (AR) device. In some examples, the display 123 is the display of the user device 152.

The processor(s) 101 may be formed in a substrate configured to execute one or more machine executable instructions or pieces of software, firmware, or a combination thereof. The processor(s) 101 can be semiconductor-based-that is, the processors can include semiconductor material that can perform digital logic. The memory device(s) 103 may include a main memory that stores information in a format that can be read and/or executed by the processor(s) 101. The memory device(s) 103 may store the application 146, the operating system 186, and/or the 3D client manager 155 that, when executed by the processors 101, perform certain operations discussed herein. In some examples, the memory device(s) 103 includes a non-transitory computer-readable medium that includes executable instructions that cause at least one processor (e.g., the processors 101) to execute operations.

The server computer(s) 160 may be computing devices that take the form of a number of different devices, for example a standard server, a group of such servers, or a rack server system. In some examples, the server computer(s) 160 may be a single system sharing components such as processors and memories. In some examples, the server computer(s) 160 may be multiple systems that do not share processors and memories. The network 150 may include the Internet and/or other types of data networks, such as a local area network (LAN), a wide area network (WAN), a cellular network, satellite network, or other types of data networks. The network 150 may also include any number of computing devices (e.g., computers, servers, routers, network switches, etc.) that are configured to receive and/or transmit data within network 150. Network 150 may further include any number of hardwired and/or wireless connections.

The video manager 102 (or a portion thereof) may be executable by one or more server computers 160. The server computer(s) 160 may include one or more processors 161 formed in a substrate, an operating system (not shown) and one or more memory devices 163. The memory device(s) 163 may represent any kind of (or multiple kinds of) memory (e.g., RAM, flash, cache, disk, tape, etc.). In some examples (not shown), the memory devices may include external storage, e.g., memory physically remote from but accessible by the server computer(s) 160. The processor(s) 161 may be formed in a substrate configured to execute one or more machine executable instructions or pieces of software, firmware, or a combination thereof. The processor(s) 161 can be semiconductor-based-that is, the processors can include semiconductor material that can perform digital logic. The memory device(s) 163 may store information in a format that can be read and/or executed by the processor(s) 161. The memory device(s) 163 may store the video manager 102 (or a portion thereof) that, when executed by the processor(s) 161, performs certain operations discussed herein. In some examples, the memory device(s) 163 includes a non-transitory computer-readable medium that includes executable instructions that cause at least one processor (e.g., the processor(s) 161) to execute operations.

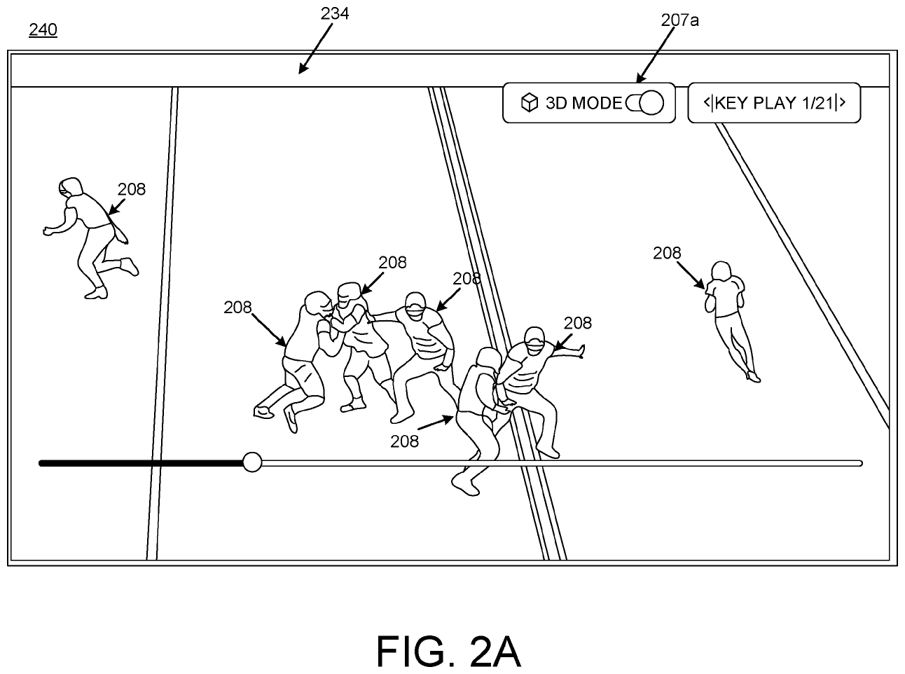

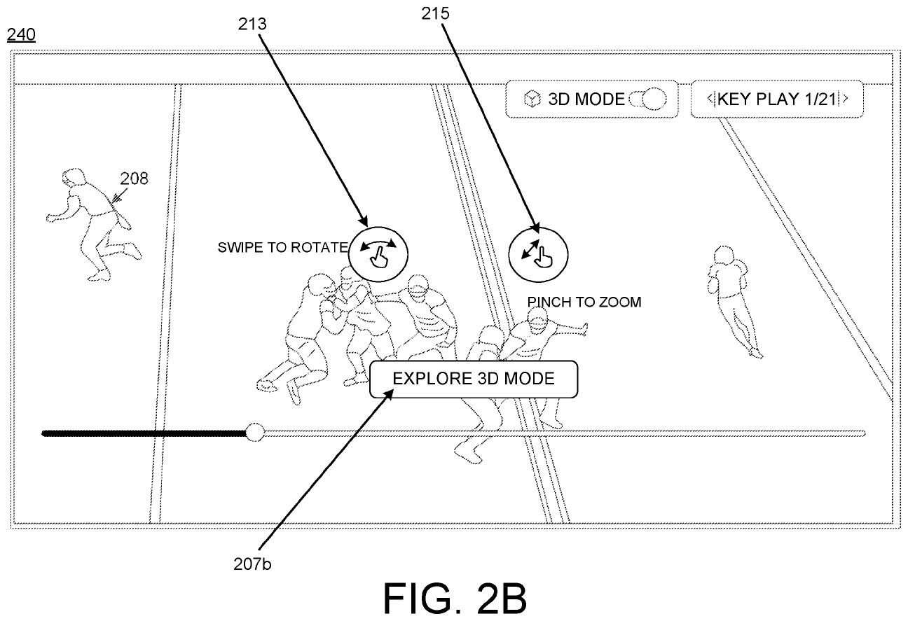

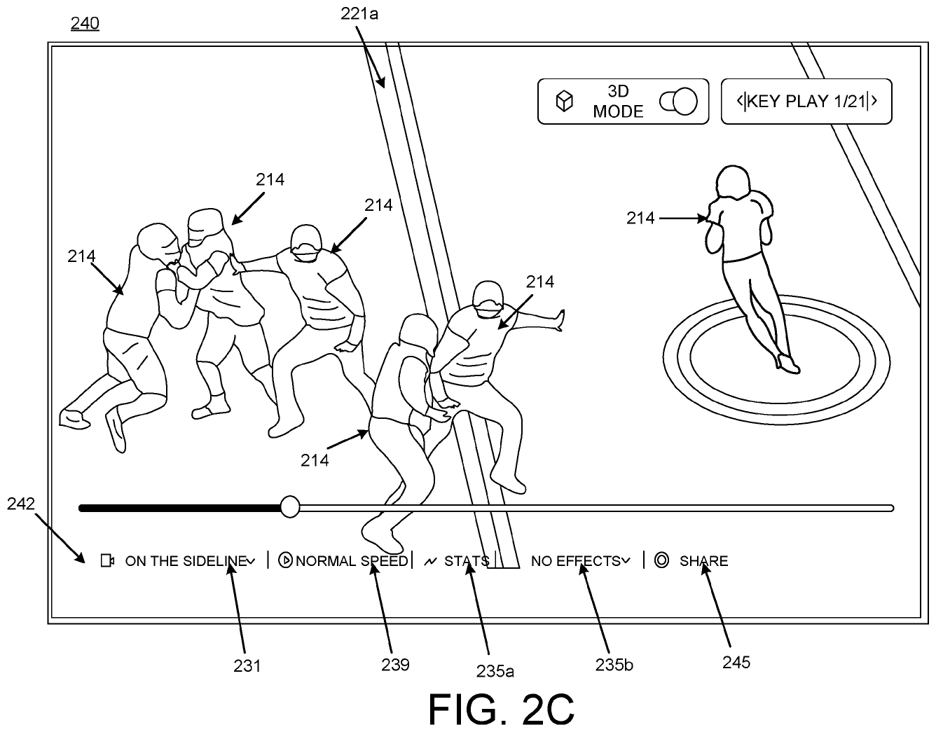

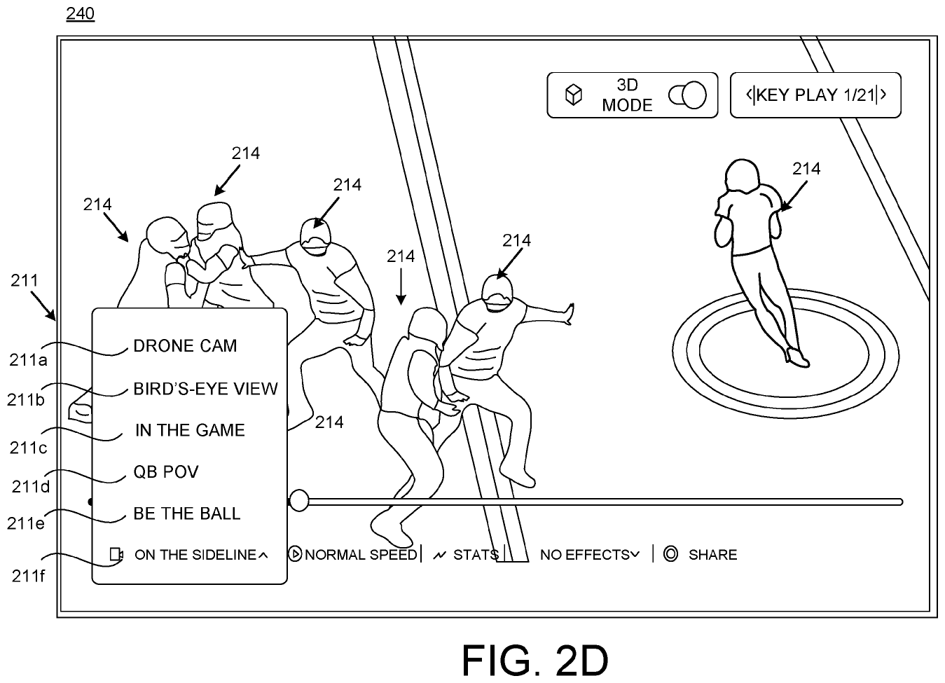

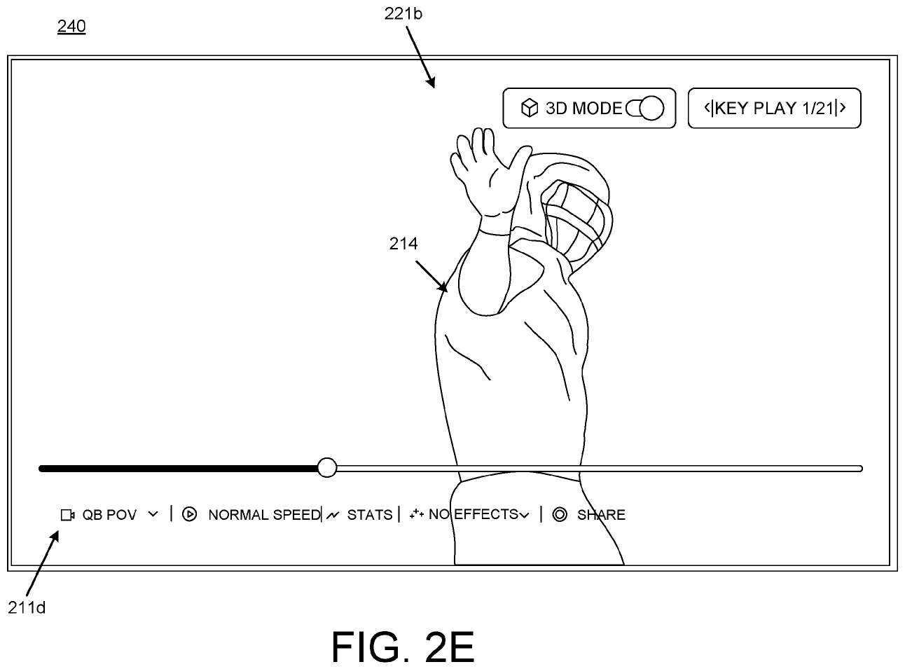

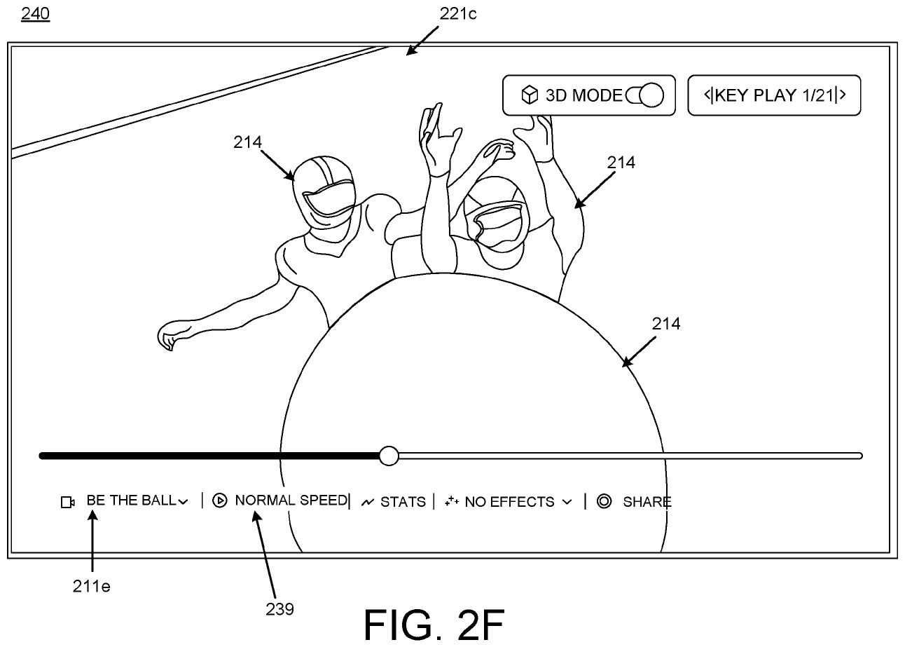

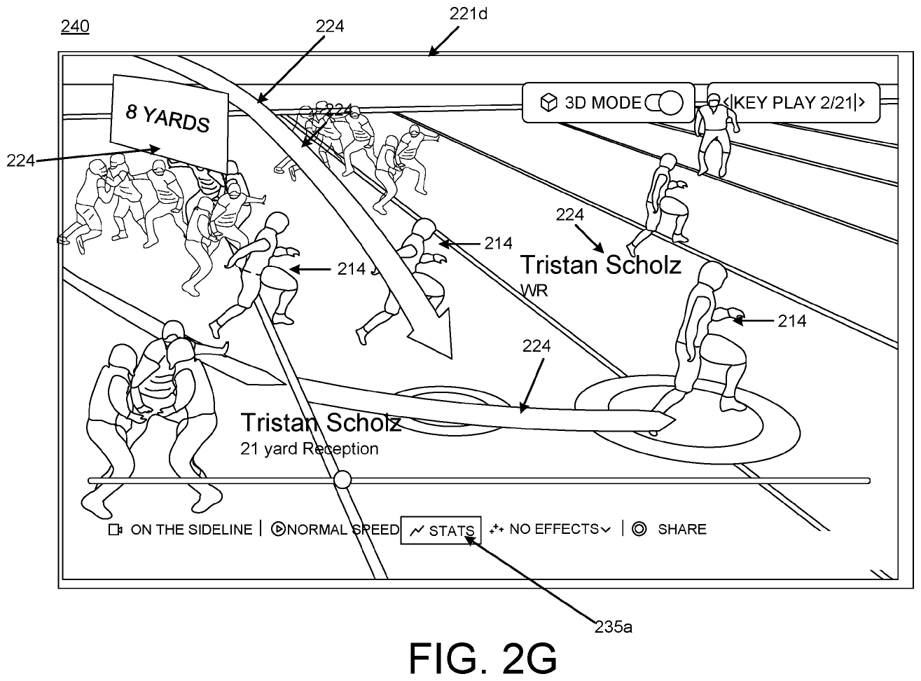

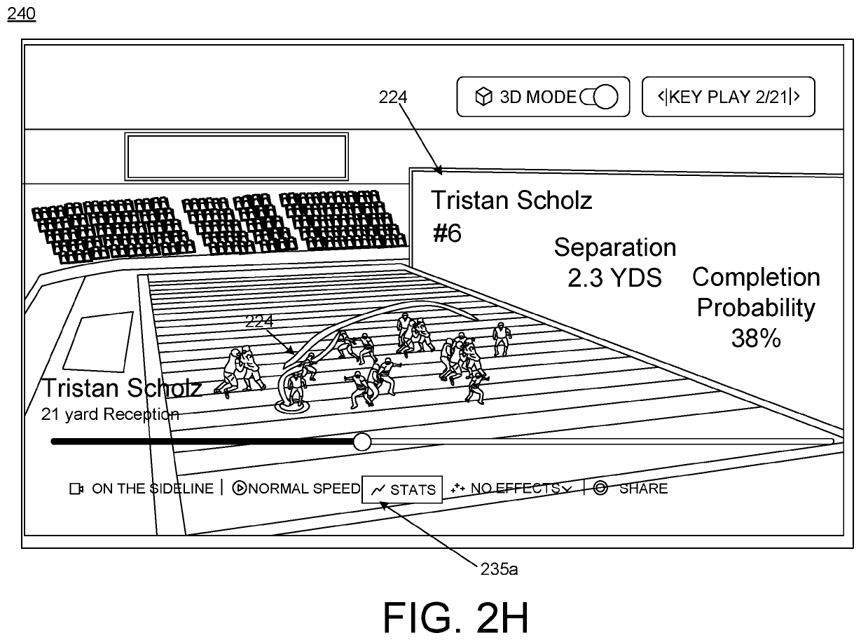

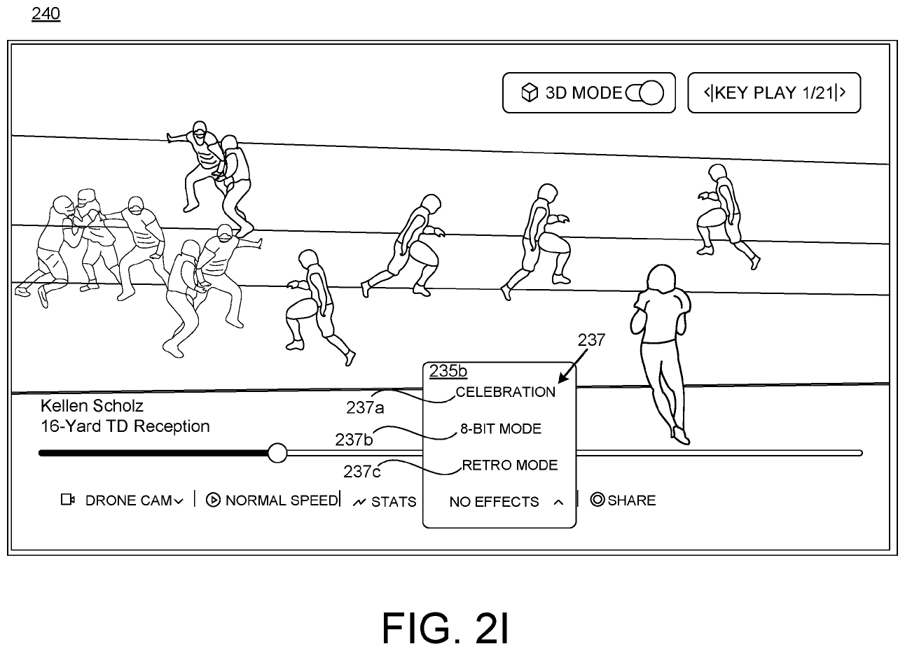

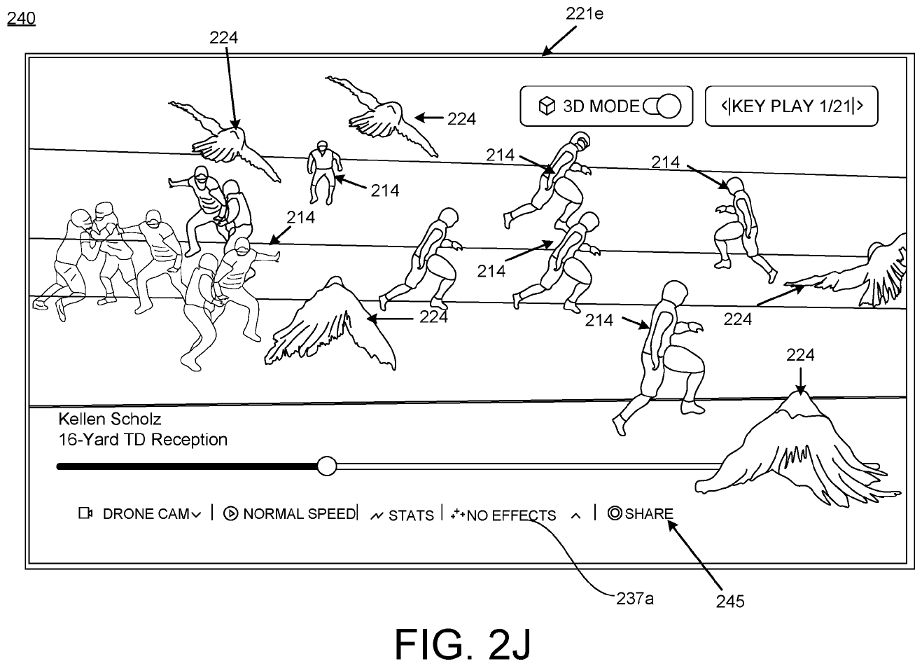

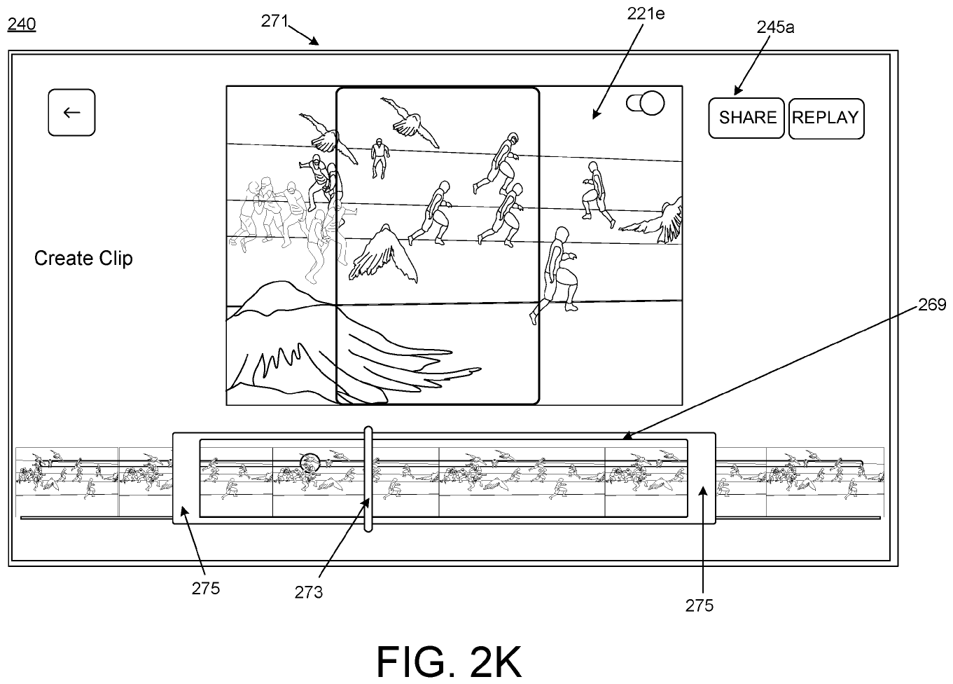

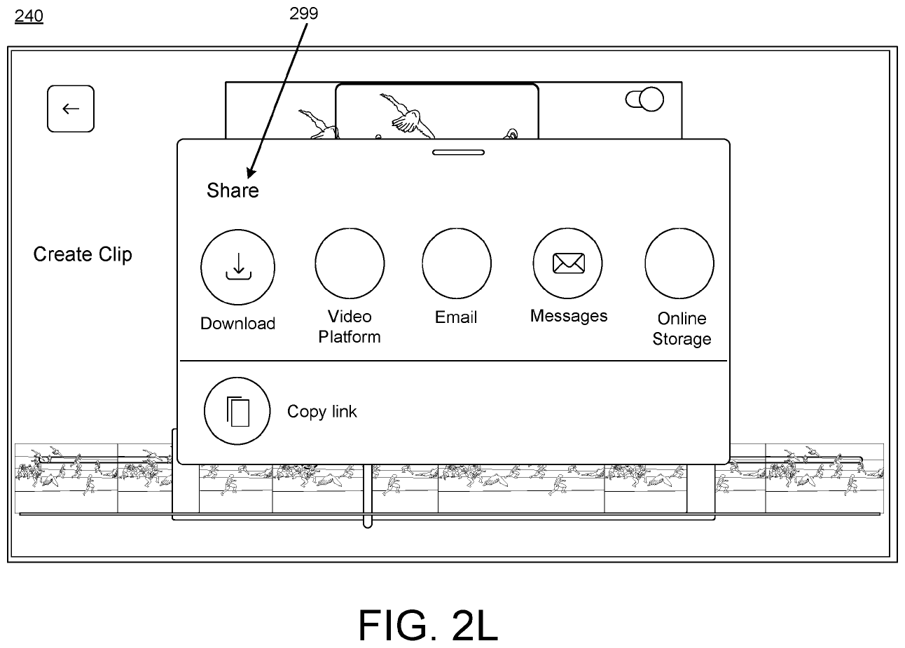

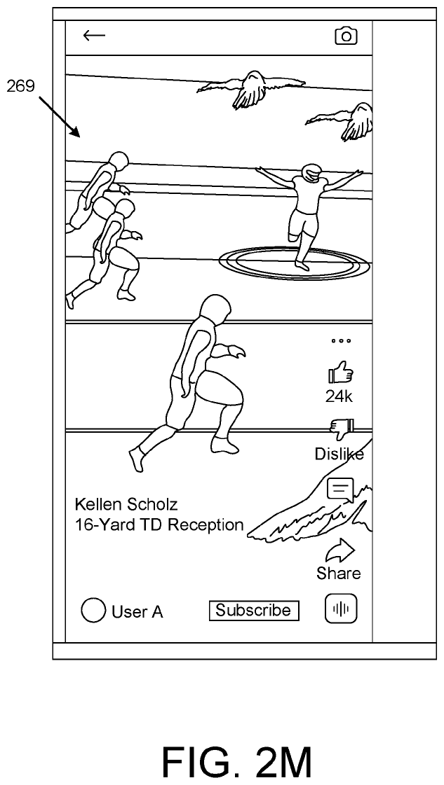

FIGS. 2A through 2M illustrate examples of one or more interfaces 240 of an application that displays a 3D video segment and user controls for controlling the 3D video segment according to an aspect.

As shown in FIG. 2A, the interface 240 may display a 2D video segment 234. The 2D video segment 234 may be a highlight from a football program. In some examples, the football program is still live (e.g., being captured by the camera system 132 of FIGS. 1A through 1N). The 2D video segment 234 may relate to a previous key play in the football program. The 2D video segment 234 may be one of a number of key plays in the football program. The 2D video segment 234 may be an example of the 2D video segment 134a of FIGS. 1A through 1N. For example, the segment selector 128 may have detected a key event 127 in the 2D footage and selected the 2D video segment 234 as a highlight to be included in the key plays of the football program. In some examples, in response to the 2D video segment 234 being detected as a highlight, the 3D video generator 104 of FIGS. 1A through 1N may generate a 3D video segment. The 2D video segment 234 includes a plurality of objects 208. The objects 208 are body structures of the football players.

As shown in FIG. 2A, the interface 240 includes a UI element 207a, which, when selected, enables the user to view the 2D video segment 234 in a 3D format. The UI element 207a may be an example of the UI element 107 of FIGS. 1A through 1N. The user may select the UI element 207a at any time during the display of the 2D video segment 234 (or after the 2D video segment 234 has ended). In some examples, in response to selection of the UI element 207a, as shown in FIG. 2B, the interface 240 may display a UI information element 213 (e.g., “swipe to rotate”) and a UI information element 215 (“pinch to zoom”) about user selections which can adjust the view of the 3D video segment. The interface 240 may also display a UI element 207b (“explore in 3D”), which, when selected, causes a 3D viewing request (e.g., the 3D viewing request 184 of FIGS. 1A through 1N) to be transmitted to a streaming engine 120 (e.g., the streaming engine 120 of FIGS. 1A through 1N). In some examples, selection of the UI element 207a causes the 3D viewing request to be transmitted to the streaming engine.

As shown in FIG. 2C, the interface 240 displays 3D video content 221a. The 3D video content 221a includes a plurality of animated objects 214 that move in a manner that corresponds to the movement of the object 208 in the 2D video segment 234. The animated objects 214 may include the players and the ball. Each animated object 214 may be an example of the animated object 114 of FIGS. 1A through 1N. In response to the 3D viewing request, the streaming engine may obtain a 3D video segment (e.g., the 3D video segment 122 of FIGS. 1A to 1N) corresponding to the 2D video segment 234. The streaming engine may generate the 3D video content 221a from the 3D video segment and transmit the 3D video content 221a to the user device for display on the interface 240. In some examples, for an initial view, the streaming engine may select default settings for the user controls 242 and generate the 3D video content 221a from the 3D video segment according to the default settings.

The interface 240 includes a plurality of user controls 242 to adjust the playback of the 3D video segment. The user controls 242 include a viewing angle control 231 configured to enable the user to adjust the viewing angle and a viewing speed control 239 configured to enable the user to adjust the viewing speed of the playback. The user controls 242 may include a statistic setting control 235a, which, when enabled, inserts statistics (including graphics) into the display of the 3D video segment. The user controls 242 may include an effect setting control 235b, which, when enabled, inserts one or more animation effects into the display of the 3D video segment. The user controls 242 may include a share control 245, which, when selected, provides one or more interfaces to enable the user to share 3D video content with other users.

In response to selection of the viewing angle control 231, as shown in FIG. 2D, the interface 240 displays a menu with a plurality of viewing angles 211. The viewing angles 211 may include viewing angle 211a (drone cam), viewing angle 211b (bird's-eye view), viewing angle 211c (in the game), viewing angle 211d (quarterback point of view), viewing angle 211e (be the ball), and viewing angle 211f (on the sideline).

In response to selection of viewing angle 211d, the application may transmit information about the user selection (e.g., the viewing angle 211d) to the streaming engine. The streaming engine may generate 3D video content 221b from the 3D video segment according to the user selection and transmit the 3D video content 221b to the application for display on the interface 240, as shown in FIG. 2E. The 3D video content 221b depicts the highlight from the point of view of the quarterback.

In response to selection of viewing angle 211e, the application may transmit information about the user selection (e.g., the viewing angle 211e) to the streaming engine. The streaming engine may generate 3D video content 221c from the 3D video segment according to the user selection and transmit the 3D video content 221c to the application for display on the interface 240, as shown in FIG. 2F. The 3D video content 221c depicts the highlight from the point of view of the ball. In some examples, the user may adjust a viewing speed of the playback. For example, referring to FIG. 2F, the user used the viewing speed control 239 to adjust the viewing speed to a slow motion speed to view the 3D video segment from the perspective of the ball and in slow motion. In some examples, the application may transmit information about the user selection (e.g., slow motion speed) and the streaming engine may adjust the playback to the slow motion speed. In some examples, the speed of the playback is controlled by the application.

In response to selection of the statistic setting control 235a, the application may transmit information about the user selection (e.g., statistic setting control 235a) to the streaming engine. The streaming engine may generate 3D video content 221d from the 3D video segment according to the user selection and transmit the 3D video content 221d to the application for display on the interface 240, as shown in FIGS. 2G and 2H. The 3D video content 221d depicts the animated objects 214 with virtual content 224 (e.g., graphics and/or statistics about the play) being added to the replay.

In response to selection of the effect setting control 235b, as shown in FIG. 2I, the interface 240 displays a menu with a plurality of effect options 237. The effect options 237 may include an effect option 237a (celebration), an effect option 237b (eight-bit mode), and an effect option 237c (retro mode). In response to selection of the effect option 237a, the application may transmit information about the user selection (e.g., the effect option 237a) to the streaming engine. The streaming engine may generate 3D video content 221e from the 3D video segment according to the user selection and transmit the 3D video content 221e to the application for display on the interface 240, as shown in FIG. 2E. The 3D video content 221e depicts the animated objects 214 with virtual content 224 added to the 3D scene.

In response to selection of the share control 245, the application may display a clip creator interface 271 that enables the user to create a video clip 269 that includes a portion of the 3D video content 221e. The video clip 269 with the portion of the 3D video content 221e may be shared with one or more other users. The video clip 269 may be an example of the customized 3D video content 121a of FIGS. 1A to 1N. The clip creator interface 271 may include one or more movable elements 275 to enable the user to define the beginning and end of the video clip and a progress indicator 273 showing a temporal position of which video frame is currently displayed. The user may use the progress indicator 273 to move back and forth in the video clip. After the user has finished editing the video clip, the user may select share element 245a, and the application may display a share interface 299 with a plurality of share options for sharing the video clip 269. The user may download the video clip 269, post the video clip 269 to one or more social or media platforms for discovery by other users, transmit the video clip 269 via email or direct message, and/or upload to an online storage system. In some examples, if the user has posted the video clip 269 to a social or media platform, other users may discover a message that identifies the video clip 269 and select the video clip 269 to watch the user's customized 3D highlight video.

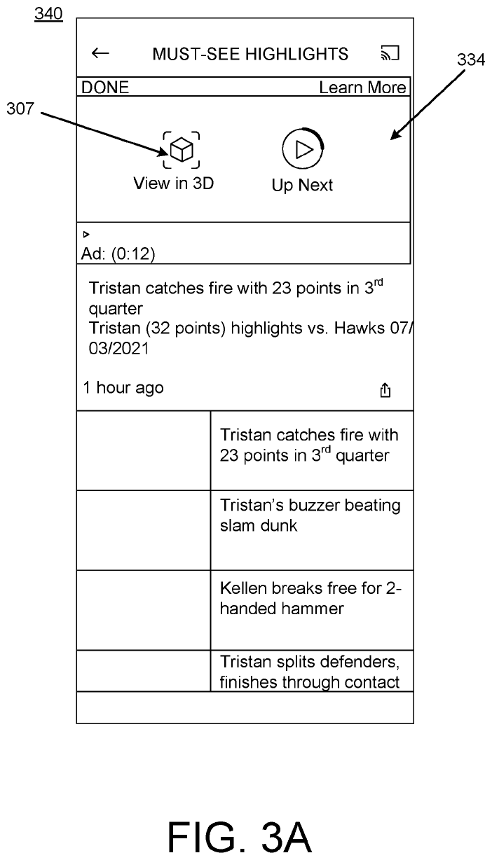

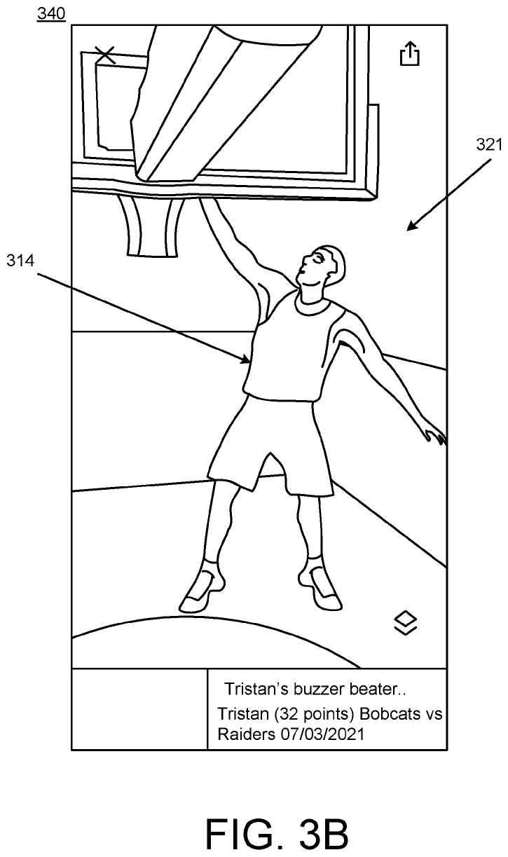

FIGS. 3A and 3B illustrate an example of an interface 340 of an application. The interface 340 may display highlights of basketball games. For example, the interface 340 may display a 2D video segment 334 of a basketball play. The interface 340 may display a UI element 307, which, when selected, causes the 2D video segment 334 to be viewable in a 3D format.

In some examples, in response to selection of the UI element 307, the application (or a 3D client manager (e.g., the 3D client manager 155 of FIGS. 1A to 1N) in communication with the application) may transmit a 3D viewing request (e.g., the 3D viewing request 184 of FIGS. 1A to 1N) to a video manager (e.g., the video manager 102 of FIGS. 1A to 1N). In some examples, the video manager is configured to generate a 3D video segment (e.g., the 3D video segment 122 of FIGS. 1A to 1N) from the 2D video segment 334. In some examples, the video manager may retrieve an already-created 3D video segment from a video database. In response to the 3D viewing request, as shown in FIG. 3B, the interface 340 may display 3D video content 321. The 3D video content 321 includes an animated object 314 (e.g., the animated object 114 of FIGS. 1A to 1N) that moves in a manner that corresponds to the movement of the player in the 2D video segment 334.

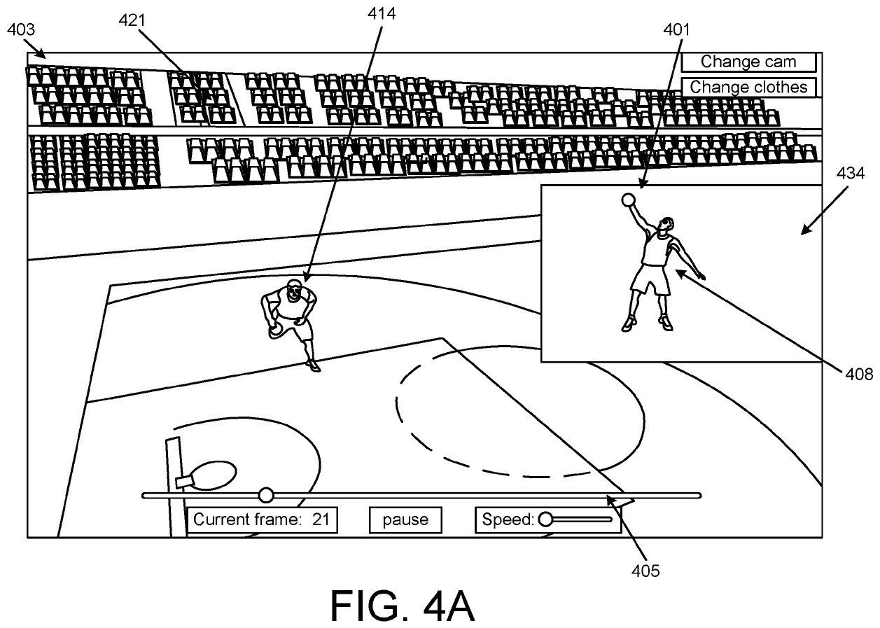

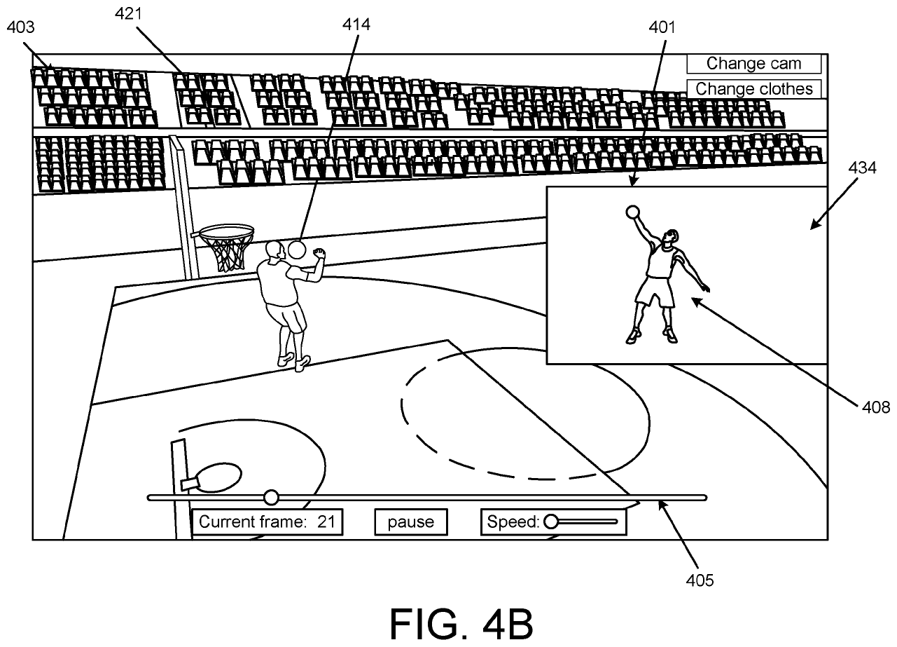

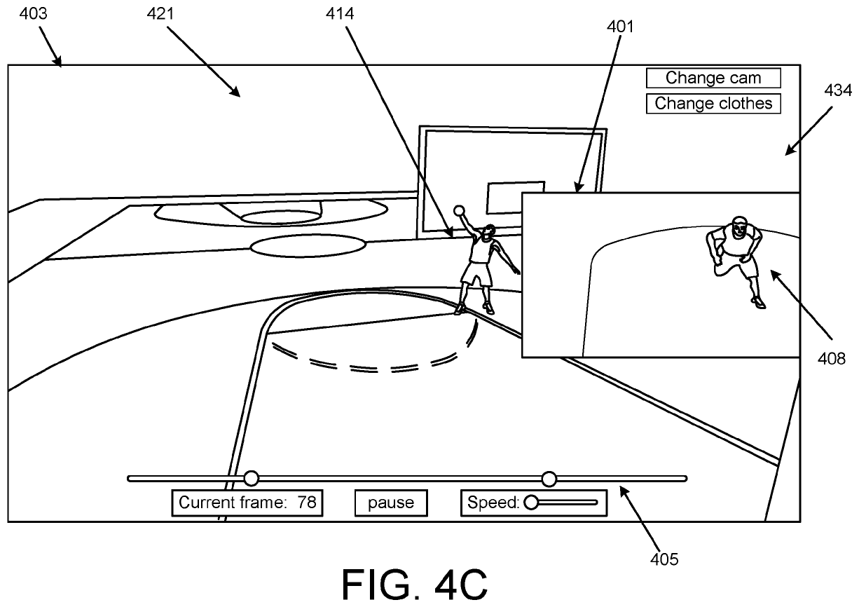

FIGS. 4A to 4C illustrate a comparison view of a display 401 of 2D video content 434 with an object 408 (e.g., a basketball player) and a display 403 with 3D video content 421 with an animated object 414 in a timeline 405. FIG. 4A illustrates a frame of the 2D video content 434 along with the corresponding frame of the 3D video content 421 at a point in the timeline 405. FIG. 4B illustrates a frame of the 2D video content 434 along with the corresponding frame of the 3D video content 421 at a subsequent point in the timeline 405. FIG. 4C illustrates a frame of the 2D video content 434 along with the corresponding frame of the 3D video content 421 at a subsequent point in the timeline 405. As shown in FIGS. 4A to 4C, the animated object 414 may move in a manner that corresponds to the movement of the object 408.

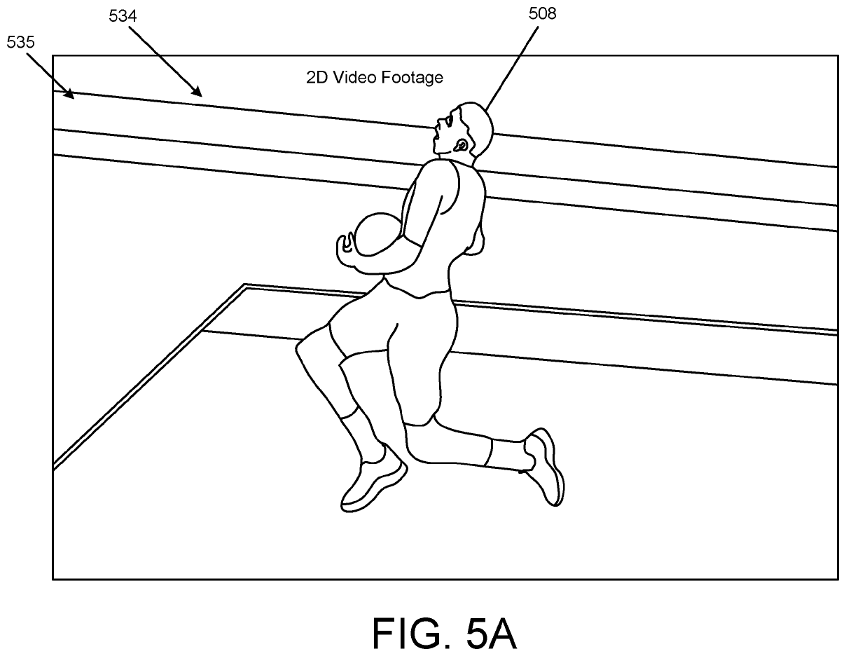

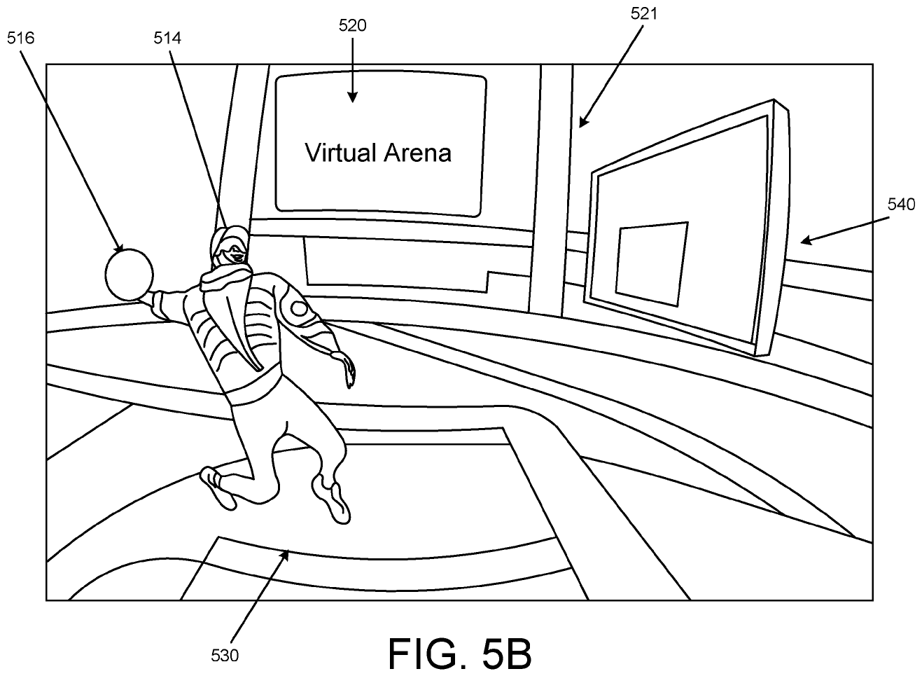

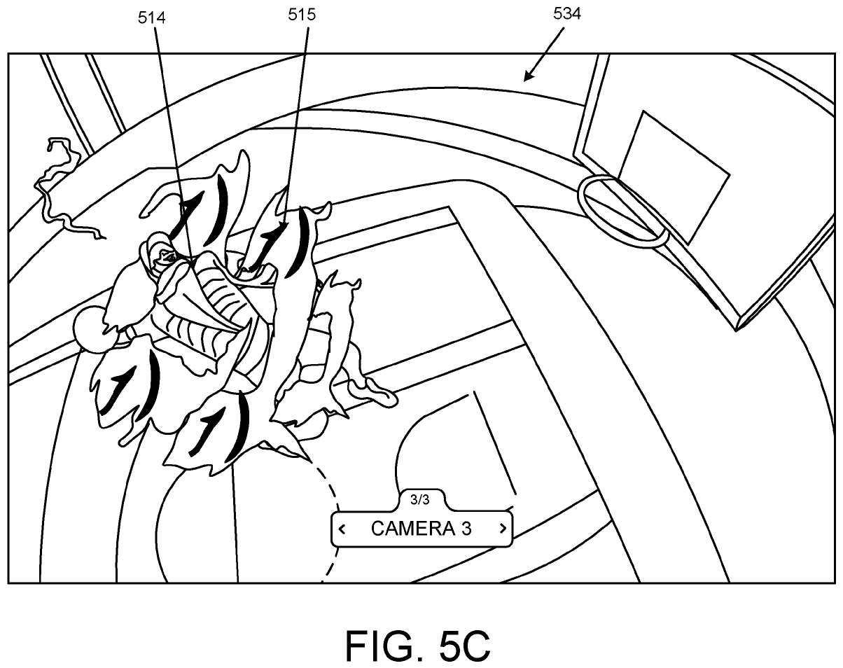

FIGS. 5A to 5C illustrate an example of 3D video content 521 created from 2D video content 534 in which an animated object 514 in the 3D video content 521 can move in a manner that corresponds to the movement of the object 508 in the 2D video content 534. FIG. 5A illustrates a video frame 535 from 2D video content 534. The 2D video content 534 includes an object 508 (e.g., a basketball player making a dunk). FIG. 5B illustrates 3D video content 521 with an animated object 514 configured to move in a manner that corresponds to the movement of the object 508 in the 2D video content 521. The 3D video content 521 also includes other computer-generated content such as virtual object 540 (e.g., basketball backboard and hoop), virtual object 516 (e.g., a ball), virtual object 530 (e.g., court), and virtual object 520 (e.g., background graphics). The animated object 514 may be the user's avatar that has been augmented with the 3D movement data so that the animated object 514 can move in the same/similar manner as the basketball player in the 3D video content 521. In some examples, one or more aspects of the animated object 514 may be modified by the user (e.g., changing the outfit, adding accessories, etc.). Referring to FIG. 5C, the user may add one or more animation effects 515 to the animated object 514 and/or the 3D scene.

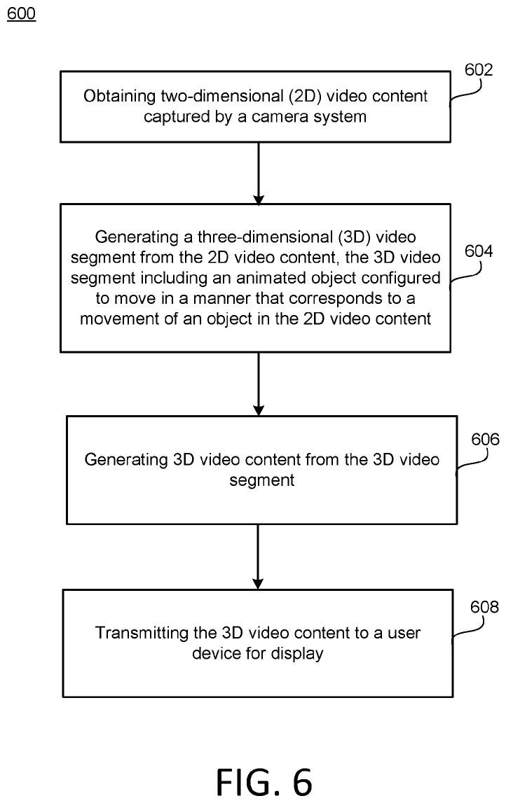

FIG. 6 is a flowchart 600 depicting example operations of a system for generating and distributing 3D video segments. The flowchart 600 may depict operations of a computer-implemented method. Although the flowchart 600 is explained with respect to the system 100 of FIGS. 1A through 1N, the flowchart 600 may be applicable to any of the implementations discussed herein. Although the flowchart 600 of FIG. 6 illustrates the operations in sequential order, it will be appreciated that this is merely an example, and that additional or alternative operations may be included. Further, operations of FIG. 6 and related operations may be executed in a different order than that shown, or in a parallel or overlapping fashion.

Operation 602 includes obtaining two-dimensional (2D) video content 134 captured by a camera system 132. Operation 604 includes generating a three-dimensional (3D) video segment 122 from the 2D video content 134, the 3D video segment 122 including an animated object 114 configured to move in a manner that corresponds to a movement of an object 108 in the 2D video content 134. In some examples, the generating includes obtaining, from a 3D pose estimation engine 188, 3D movement data 110 of an object 108 detected in the 2D video content 134 and generating an animated object 114 based on the 3D movement data 110 such that a movement of the animated object 114 corresponds to a movement of the object 108 in the 2D video content 134. Operation 606 includes generating 3D video content 121 from the 3D video segment 122. Operation 608 includes transmitting the 3D video content 121 to a user device 152 for display.

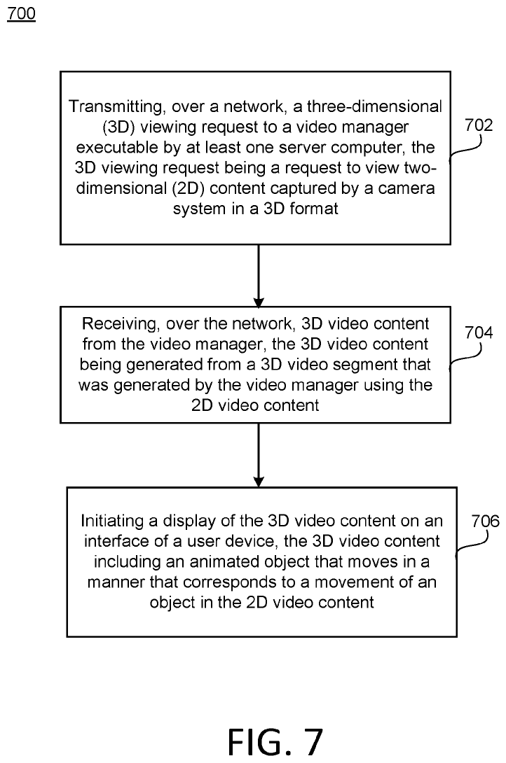

FIG. 7 is a flowchart 700 depicting example operations of a system for rendering 3D video segments. The flowchart 700 may depict operations of a computer-implemented method. Although the flowchart 700 is explained with respect to the system 100 of FIGS. 1A through 1N, the flowchart 600 may be applicable to any of the implementations discussed herein. Although the flowchart 700 of FIG. 7 illustrates the operations in sequential order, it will be appreciated that this is merely an example, and that additional or alternative operations may be included. Further, operations of FIG. 7 and related operations may be executed in a different order than that shown, or in a parallel or overlapping fashion.

Operation 702 includes transmitting, over a network 150, a three-dimensional (3D) viewing request 184 to a video manager 102 executable by at least one server computer 160, the 3D viewing request 184 being a request to view two-dimensional (2D) video content 134 captured by a camera system 132 in a 3D format. Operation 704 includes receiving, over the network 150, 3D video content 121 from the video manager 102, the 3D video content 121 being generated from a 3D video segment 122 that was generated by the video manager 102 using the 2D video content 134. Operation 706 includes initiating a display of the 3D video content 121 on an interface 140 of a user device 152, the 3D video content 121 including an animated object 114 that moves in a manner that corresponds to a movement of an object 108 in the 2D video content 134.

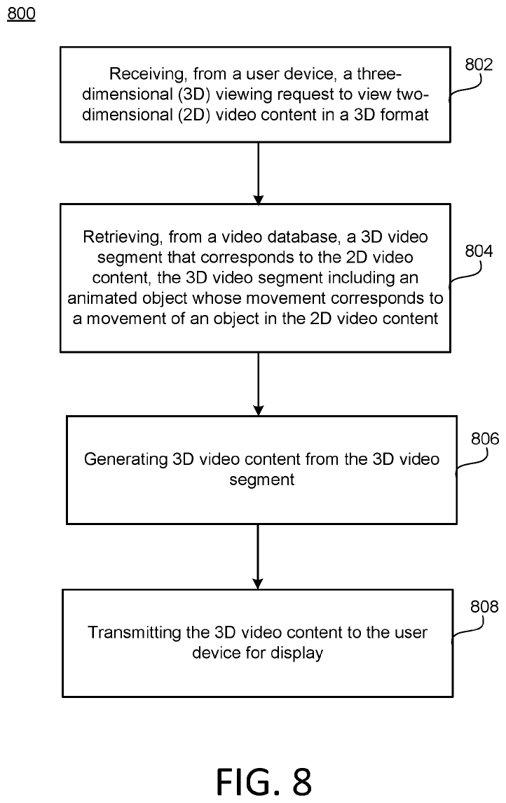

FIG. 8 is a flowchart 800 depicting example operations of a system for retrieving and distributing 3D video segments. The flowchart 800 may depict operations of a computer-implemented method. Although the flowchart 800 is explained with respect to the system 100 of FIGS. 1A through 1N, the flowchart 800 may be applicable to any of the implementations discussed herein. Although the flowchart 800 of FIG. 8 illustrates the operations in sequential order, it will be appreciated that this is merely an example, and that additional or alternative operations may be included. Further, operations of FIG. 8 and related operations may be executed in a different order than that shown, or in a parallel or overlapping fashion.

Operation 802 includes receiving, from a user device 152, a three-dimensional (3D) viewing request 184 to view two-dimensional (2D) video content 134 in a 3D format. Operation 804 includes retrieving, from a video database 196, a 3D video segment 122 that corresponds to the 2D video content 134, the 3D video segment 122 including an animated object 114 whose movement corresponds to a movement of an object 108 in the 2D video content 134. Operation 806 includes generating 3D video content 121 from the 3D video segment 122. Operation 808 includes transmitting the 3D video content 121 to the user device 152 for display.

Clause 1. A method comprising: generating a three-dimensional (3D) video segment from two-dimensional (2D) video content captured by a camera system, including: obtaining, from a 3D pose estimation engine, 3D movement data of an object detected in the 2D video content; and generating an animated object based on the 3D movement data such that a movement of the animated object corresponds to a movement of the object in the 2D video content; generating 3D video content from the 3D video segment; and transmitting the 3D video content to a user device for display

Clause 2. The method of clause 1, further comprising: receiving, from the user device, a 3D viewing request to view at least a portion of the 2D video content in a 3D format; and in response to the 3D viewing request, generating the 3D video content from the 3D video segment.

Clause 3. The method of clause 1, further comprising: storing the 3D video segment in a video database; receiving, from the user device, a 3D viewing request to view at least a portion of the 2D video content in a 3D format; and in response to the 3D viewing request: retrieving the 3D video segment from the video database; and generating the 3D video content from the 3D video segment.

Clause 4. The method of any one of clauses 1 to 3, wherein the 2D video content includes television content, further comprising: detecting that a portion of the television content includes a key event; identifying a 2D video segment from the portion of the television content; and generating the 3D video segment from the 2D video segment.

Clause 5. The method of any one of clauses 1 to 4, wherein the 3D video content is first 3D video content, the method further comprising: receiving, from the user device, information that indicates a user selection to adjust playback of the 3D video segment; generating second 3D video content based on the 3D video segment and the user selection; and transmitting the second 3D video content to the user device for display.

Clause 6. The method of clause 5, wherein the user selection includes at least one of an adjustment to a viewing angle or an adjustment to a characteristic of the animated object.

Clause 7. The method of clause 5 or 6, wherein the user selection includes a selection of virtual content, the virtual content including at least one of statistical data or an animation effect.

Clause 8. The method of any one of clauses 1 to 7, wherein generating the 3D movement data includes estimating a 3D position of at least one of a plurality of keypoints of the object from a 2D position of the object in a plurality of frames of 2D video content.

Clause 9. The method of any one of clauses 1 to 8, further comprising: generating the animated object by applying the 3D movement data to a 3D object model that represents the object detected in the 2D video content.

Clause 10. The method of clause 9, further comprising: selecting, from an object model database, the 3D object model based on object data associated with the object; or generating the 3D object model based on the 2D video content.

Clause 11. The method of any one of clauses 1 to 10, wherein the 3D movement data includes positional and rotational information that describes movement and orientation of the object in 3D space.

Clause 12. A non-transitory computer-readable medium storing executable instructions that cause at least one processor to execute operations, the operations comprising: transmitting, over a network, a three-dimensional (3D) viewing request to a video manager executable by at least one server computer, the 3D viewing request being a request to view two-dimensional (2D) content captured by a camera system in a 3D format; receiving, over the network, 3D video content from the video manager, the 3D video content being generated from a 3D video segment that was generated by the video manager using the 2D video content; and initiating a display of the 3D video content on an interface of a user device, the 3D video content including an animated object whose movement corresponds to a movement of an object in the 2D video content.

Clause 13. The non-transitory computer-readable medium of clause 12, wherein the 3D video content is first 3D video content, the interface including a user control configured to enable a user to adjust playback of the 3D video segment, wherein the operations further comprise: transmitting, over the network, information that indicates a user selection to the user control; and receiving, over the network, second 3D video content with imagery according to the user selection.

Clause 14. The non-transitory computer-readable medium of clause 13, wherein the user control includes a viewing angle control configured to enable the user to adjust a viewing angle of the 3D video segment.

Clause 15. The non-transitory computer-readable medium of clause 13or 14, wherein the user control includes a virtual content control configured to enable the user to add virtual content to the playback of the 3D video segment.

Clause 16. The non-transitory computer-readable medium of any one of clauses 13 to 15, wherein the user control includes an object customization control configured to enable the user to modify a characteristic of the animated object.

Clause 17. The non-transitory computer-readable medium of any one of clauses 12 to 16, wherein the 3D video segment is a first 3D video segment, wherein the interface includes a search field configured to enable a user to submit a search query, wherein the operations further comprise: in response to submission of the search query, receiving at least one search result that identifies a second 3D video segment responsive to the search query.

Clause 18. The non-transitory computer-readable medium of any one of clauses 12 to 17, wherein the user device is a first user device, the interface including a share control configured to enable a user to share customized 3D video content with a second user device.

Clause 19. An apparatus comprising: at least one processor; and a non-transitory computer-readable medium storing executable instructions that cause the at least one processor to: receive, from a user device, a three-dimensional (3D) viewing request to view two-dimensional (2D) video content in a 3D format; retrieve, from a video database, a 3D video segment that corresponds to the 2D video content, the 3D video segment including an animated object whose movement corresponds to a movement of an object in the 2D video content; generate 3D video content from the 3D video segment; and transmit the 3D video content to the user device for display.

Clause 20. The apparatus of clause 19, wherein the 3D video content is first 3D video content, wherein the executable instructions include instructions that cause that the at least one processor to: receive, from the user device, information that indicates a user selection to adjust playback of the 3D video segment; generate second 3D video content based on the 3D video segment and the user selection; and transmit the second 3D video content to the user device for display.

Clause 21. The apparatus of clause 20, wherein the user selection includes at least one of an adjustment to a viewing angle or an adjustment to a characteristic of the animated object.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B”includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

1. A method comprising:
generating a three-dimensional (3D) video segment from two-dimensional (2D) video content captured by a camera system, including:
obtaining, from a 3D pose estimation engine, 3D movement data of an object detected in the 2D video content; and
generating an animated object based on the 3D movement data such that a movement of the animated object corresponds to a movement of the object in the 2D video content;
generating 3D video content from the 3D video segment; and
transmitting the 3D video content to a user device for display.

2. The method of claim 1, further comprising:
receiving, from the user device, a 3D viewing request to view at least a portion of the 2D video content in a 3D format; and
in response to the 3D viewing request, generating the 3D video content from the 3D video segment.

3. The method of claim 1, further comprising:
storing the 3D video segment in a video database;
receiving, from the user device, a 3D viewing request to view at least a portion of the 2D video content in a 3D format; and
in response to the 3D viewing request:
retrieving the 3D video segment from the video database; and
generating the 3D video content from the 3D video segment.

4. The method of claim 1, wherein the 2D video content includes television content, further comprising:
detecting that a portion of the television content includes a key event;
identifying a 2D video segment from the portion of the television content; and
generating the 3D video segment from the 2D video segment.

5. The method of claim 1, wherein the 3D video content is first 3D video content, the method further comprising:
receiving, from the user device, information that indicates a user selection to adjust playback of the 3D video segment;
generating second 3D video content based on the 3D video segment and the user selection; and
transmitting the second 3D video content to the user device for display.

6. The method of claim 5, wherein the user selection includes at least one of an adjustment to a viewing angle or an adjustment to a characteristic of the animated object.

7. The method of claim 5, wherein the user selection includes a selection of virtual content, the virtual content including at least one of statistical data or an animation effect.

8. The method of claim 1, wherein generating the 3D movement data includes estimating a 3D position of at least one of a plurality of keypoints of the object from a 2D position of the object in a plurality of frames of 2D video content.

9. The method of claim 1, further comprising:
generating the animated object by applying the 3D movement data to a 3D object model that represents the object detected in the 2D video content.

10. The method of claim 9, further comprising:
selecting, from an object model database, the 3D object model based on object data associated with the object; or
generating the 3D object model based on the 2D video content.

11. The method of claim 1, wherein the 3D movement data includes positional and rotational information that describes movement and orientation of the object in 3D space.

12. A non-transitory computer-readable medium storing executable instructions that cause at least one processor to execute operations, the operations comprising:
transmitting, over a network, a three-dimensional (3D) viewing request to a video manager executable by at least one server computer, the 3D viewing request being a request to view two-dimensional (2D) video content captured by a camera system in a 3D format;
receiving, over the network, 3D video content from the video manager, the 3D video content being generated from a 3D video segment that was generated by the video manager using the 2D video content; and
initiating a display of the 3D video content on an interface of a user device, the 3D video content including an animated object whose movement corresponds to a movement of an object in the 2D video content.

13. The non-transitory computer-readable medium of claim 12, wherein the 3D video content is first 3D video content, the interface including a user control configured to enable a user to adjust playback of the 3D video segment, wherein the operations further comprise:
transmitting, over the network, information that indicates a user selection to the user control; and
receiving, over the network, second 3D video content with imagery according to the user selection.

14. The non-transitory computer-readable medium of claim 13, wherein the user control includes a viewing angle control configured to enable the user to adjust a viewing angle of the 3D video segment.

15. The non-transitory computer-readable medium of claim 13, wherein the user control includes a virtual content control configured to enable the user to add virtual content to the playback of the 3D video segment.

16. The non-transitory computer-readable medium of claim 13, wherein the user control includes an object customization control configured to enable the user to modify a characteristic of the animated object.

17. The non-transitory computer-readable medium of claim 12, wherein the 3D video segment is a first 3D video segment, wherein the interface includes a search field configured to enable a user to submit a search query, wherein the operations further comprise:
in response to submission of the search query, receiving at least one search result that identifies a second 3D video segment responsive to the search query.

18. The non-transitory computer-readable medium of claim 12, wherein the user device is a first user device, the interface including a share control configured to enable a user to share customized 3D video content with a second user device.

19. An apparatus comprising:
at least one processor; and
a non-transitory computer-readable medium storing executable instructions that cause the at least one processor to:
receive, from a user device, a three-dimensional (3D) viewing request to view two-dimensional (2D) video content in a 3D format;
retrieve, from a video database, a 3D video segment that corresponds to the 2D video content, the 3D video segment including an animated object whose movement corresponds to a movement of an object in the 2D video content;
generate 3D video content from the 3D video segment; and
transmit the 3D video content to the user device for display.

20. The apparatus of claim 19, wherein the 3D video content is first 3D video content, wherein the executable instructions include instructions that cause that the at least one processor to:
receive, from the user device, information that indicates a user selection to adjust playback of the 3D video segment;
generate second 3D video content based on the 3D video segment and the user selection; and
transmit the second 3D video content to the user device for display.

21. The apparatus of claim 20, wherein the user selection includes at least one of an adjustment to a viewing angle or an adjustment to a characteristic of the animated object.
